(19) United States
(12) Patent Application Publication
(10) Pub. No.: US 2025/0217289 A1
(43) Pub. Date: Jul. 3, 2025

(54) DATA PROCESSING METHOD, SYSTEM AND APPARATUS, AND ELECTRONIC DEVICE AND STORAGE MEDIUM

(71) Applicant: Tencent Technology (Shenzhen) Company Limited, Shenzhen (CN)

(72) Inventors: Xiangwen ZOU, Shenzhen (CN); Yutao LI, Shenzhen (CN); Ran LIU, Shenzhen (CN); Zhiheng LI, Shenzhen (CN); Jianfei CHEN, Shenzhen (CN); Haifeng GAO, Shenzhen (CN); Tianqi ZHANG, Shenzhen (CN); Feng LI, Shenzhen (CN); Pan JIANG, Shenzhen (CN)

(73) Assignee: Tencent Technology (Shenzhen) Company Limited, Shenzhen (CN)

(21) Appl. No.: 19/078,410

(22) Filed: Mar. 13, 2025

Related U.S. Application Data
(63) Continuation of application No. PCT/CN2024/077909, filed on Feb. 21, 2024.

(30) Foreign Application Priority Data
Mar. 1, 2023 (CN) 202310233124.3

(51) Int. Cl. G06F 12/0802

(52) U.S. Cl. CPC G06F 12/0802

(57) ABSTRACT

A data processing method including acquiring, by a first service node in a group forwarding layer, a service processing request related to a target group from an access layer, the service processing request comprising a first group identifier of the target group, determining, by the first service node, target service nodes caching basic group data of the target group from a plurality of second service nodes in a group logic layer according to the first group identifier, the target service nodes being some nodes among the plurality of second service nodes, and transmitting, by the first service node, the service processing request to the target service nodes, such that the target service nodes determine a member size of the target group according to the basic group data of the target group and perform processing on the service processing request according to the member size of the target group.

### CROSS-REFERENCE TO RELATED APPLICATIONS

This application is a continuation application of International Application No. PCT/CN2024/077909 filed on Feb. 21, 2024 which claims priority to Chinese Patent Application No. 202310233124.3 filed with the China National Intellectual Property Administration on Mar. 1, 2023, the disclosures of each being incorporated by reference herein in their entireties.

### FIELD

The disclosure belongs to the technical field of computers, may relate to the fields of distributed memory, cloud technologies, and the like, and particularly, to a data processing method, system and apparatus, and an electronic device and a storage medium.

### BACKGROUND

With the rapid development of science and technologies and the improvement of people's living standards, various applications emerge one after another and become an indispensable part in people's daily life. To better satisfy communication and interaction requirements of people, more and more programs provide communication services, such as an instant messaging service, for users of the programs. In such services, group function (e.g., creating a chat group with two or more people) has been a common feature, and interaction among multiple people may be implemented through the group function.

In the related art at present, although group interaction may satisfy communication and interaction among multiple people or even a large number of people, various problems also appear with the increase of group members. How to optimize performance of group interaction and communication and improve users' perception is one of important problems currently needing to be solved.

### SUMMARY

Some embodiments provide a data processing method, including: acquiring, by a first service node in a group forwarding layer, a service processing request related to a target group from an access layer, the service processing request comprising a first group identifier of the target group; determining, by the first service node, target service nodes caching basic group data of the target group from a plurality of second service nodes in a group logic layer according to the first group identifier, the target service nodes being some nodes among the plurality of second service nodes; and transmitting, by the first service node, the service processing request to the target service nodes, such that the target service nodes determine a member size of the target group according to the basic group data of the target group and perform processing on the service processing request according to the member size of the target group.

Some embodiments provide a data processing apparatus, disposed in a first service node of a group forwarding layer, and including at least one memory configured to store program code; and at least one processor configured to read the program code and operate as instructed by the program code, the program code comprising: request receiving code configured to cause at least one of the at least one processor to acquire a service processing request related to a target group from an access layer, the service processing request comprising a first group identifier of the target group; target node determination code configured to cause at least one of the at least one processor to determine target service nodes caching basic group data of the target group from a plurality of second service nodes in a group logic layer according to the first group identifier, the target service nodes being some nodes among the plurality of second service nodes; and request forwarding code configured to cause at least one of the at least one processor to transmit the service processing request to the target service nodes, such that the target service nodes determine a member size of the target group according to the basic group data of the target group and perform processing on the service processing request according to the member size of the target group.

Some embodiments further provide a non-transitory computer-readable storage medium, storing computer code which, when executed by at least one processor, causes the at least one processor to at least: acquire, by a first service node in a group forwarding layer, a service processing request related to a target group from an access layer, the service processing request comprising a first group identifier of the target group; determine, by the first service node, target service nodes caching basic group data of the target group from a plurality of second service nodes in a group logic layer according to the first group identifier, the target service nodes being some nodes among the plurality of second service nodes; and transmit, by the first service node, the service processing request to the target service nodes, such that the target service nodes determine a member size of the target group according to the basic group data of the target group and perform processing on the service processing request according to the member size of the target group.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic structural diagram of a data processing system according to some embodiments.

FIG. 2 is a schematic diagram of a processing principle of an information inquiry request according to some embodiments.

FIG. 3 is a schematic diagram of a processing principle of a message mass transmitting request according to some embodiments.

FIG. 4 is a schematic flow chart of a data processing method according to some embodiments.

FIG. 5 is a schematic principle diagram of a group-related request processing solution according to some embodiments.

FIG. 6 is a schematic diagram of a group-related request processing solution in the related art.

FIG. 7 is a schematic principle diagram of member data retrieval according to some embodiments.

FIG. 8 is a schematic principle diagram of a message pushing solution according to some embodiments.

FIG. 9 is a schematic structural diagram of a data processing apparatus according to some embodiments.

FIG. 10 is a schematic structural diagram of a data processing system according to some embodiments.

FIG. 11 is a schematic structural diagram of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

A person skilled in the art may understand that, unless specifically stated, singular forms “a”, “an”, “the”, and “said” used herein may also include plural forms. Terms “include” and “comprise” used in the embodiments of this application mean that corresponding features may be implemented as presented features, information, data, steps, operations, elements, and/or components, but do not exclude implementation as other features, information, data, steps, operations, elements, components, and/or a combination thereof, and the like supported in the technical field. When an element is referred to as being “connected” or “coupled” to another element, the element may be directly connected or coupled to another element, or may mean that a connection relationship is established between the element and another element by using an intermediate element. In addition, the “connection” or “coupling” used herein may include wireless connection or wireless coupling. A term “and/or” used herein indicates at least one of items limited by the term. For example, “A and/or B” may be implemented as “A”, “B”, or “A and B”. When a plurality of (two or more) items are described, if a relationship among the plurality of items is not clearly limited, the plurality of items may refer to one, more, or all of the plurality of items. For example, the description “a parameter A includes A1, A2, and A3” may be implemented as that the parameter A includes A1, or A2, or A3, or may be implemented as that the parameter A includes at least two of the three parameters A1, A2, and A3.

In the technical solutions provided in the embodiments of this application, the first service node is added, the service processing request aiming at the target group may be only transmitted to the target service nodes associated with the target group through the first service node, that is, one group is only associated with some nodes (may be one or multiple) among the plurality of second service nodes, and each second service node may only cache data of an associated group, and does not need to cache data of a non-associated group. By using such solutions, the data of the group is cached in the target service nodes associated with the target group, processing efficiency on the request aiming at the group may be effectively improved, and an occurrence of a request hotspot problem is avoided. The data of the target group is only cached in some associated second service nodes, so the cache utilization rate may be effectively improved. In addition, it does not require each second service node to cache the data of all groups, so resource waste may also be avoided.

Some embodiments provide a data processing method. By using the method, a resource utilization rate of service nodes in a data processing system, for example, a cache utilization rate, may be effectively improved, and cache costs may be effectively reduced. Therefore, an actual application requirement may be better met.

In some embodiments, data processing in the method may be implemented based on a cloud technology. For example, data storage (for example, storage of basic group data of a group, or storage of member data in the group) involved in some embodiments may be implemented in a cloud storage mode. In some embodiments, data calculation (for example, data calculation (for example, consistent hash calculation) in target service nodes corresponding to a service processing request determined according to a group identifier) may be implemented through cloud computing.

The cloud computing is a computing mode. According to cloud computing, computing tasks are distributed on a resource pool formed by a large quantity of computers, so that various application systems may acquire computing power, storage spaces, and information services according to requirements. A network that provides resources is referred to as a “cloud”. For a user, resources in the “cloud” seem to be infinitely expandable, and may be acquired at any time, used on demands, expanded at any time, and paid for use. Cloud storage is a new concept extended and developed from the concept of cloud computing. A distributed cloud storage system (referred to as a storage system for short below) is a storage system integrating a large number of different types of storage devices (also referred to as storage nodes) in a network through functions such as cluster application, grid technologies, and distributed file storage systems through application software or application interfaces to enable the storage devices to work together to provide data storage and service access functions to the outside.

In some embodiments, a permission or agreement of an object is required, and collection, use, and processing of the relevant data need to comply with relevant laws, regulations, and standards of relevant countries and regions. That is, data related to an object may be acquired only when the data is authorized and agreed by the object, or authorized and agreed by a relevant department, and satisfies relevant laws, regulations, and standards of a country and a region. If personal information is involved in the embodiments, personal agreement needs to be obtained for acquiring all the personal information. For example, if sensitive information is involved, independent agreement of an information subject needs to be acquired. The embodiments also need to be implemented in a case that an object authorizes to agree.

A data processing method according to some embodiments may be implemented by any one electronic device, for example, implemented by a server. The method may be described from different perspectives, and operations involved with interaction between different nodes may be described from different node sides. For example, operations of interaction between a first service node (for example, a first server) and a second service node (for example, a second server) may be illustrated by using the first service node as an execution body, or may be illustrated by using the second service node as an execution body. For example, the first service node transmits a service processing request to the second service node. Correspondingly, this description may also be written as that the second service node receives a service processing request from the first service node.

In some embodiments, the server may be an independent physical server, or may be a server cluster or a distributed system formed by a plurality of physical servers, or may be a cloud server providing cloud computing services. The server may receive a service processing request initiated by a user terminal, and process the service processing request. In some embodiments, the server may further feedback a processing result of the service processing request to the user terminal.

The user terminal in some embodiments may be a smart phone, a tablet computer, a notebook computer, a desktop computer, a smart voice interactive device (such as a smart speaker), a wearable electronic device (such as a smartwatch), an on board terminal, an intelligent household electrical appliance (such as a smart television), an AR/VR device, or the like, but is not limited thereto. The user terminal and the server may be connected directly or indirectly in a wired or wireless communication manner, which is not limited herein.

The method provided in some embodiments may be applicable to any application program providing a group service. The application program may be any type of application program running on a mobile terminal or a fixed terminal, for example, including but not limited to an Application (app), an application in a form of a web page, a mini program, and the like. The application may be a dedicated instant messaging tool, or may be an application providing both an instant messaging service and other services.

To better understand and illustrate the method provided by some embodiments, some terms are illustrated below.

Access layer: similar to a gateway, for example, a software development kit (SDK) of an application program may request a back-end server by using the access layer.

Group forwarding layer: configured to forward a group request forwarded by the access layer to a group logic layer.

Group logic layer: a group-related logic processing service.

Consistent Hash: a load balance strategy for forwarding a group request to a back-end service according to some information (the information may be selected and configured according to an actual requirement) in the request. The consistent Hash differs from other load balance strategies in that some requests with the same information will be necessarily forwarded to the same machine or several machines at the backend.

Community: a group capable of supporting millions of persons.

Small group: a group with a quantity of persons less than a first quantity, for example, a group with a quantity of persons less than 1000.

Big group: a group with a quantity of persons more than or equal to the first quantity but less than a second quantity, for example, a group with a quantity of persons more than 1000 but less than 50000.

Super big group: a group with a quantity of persons more than the second quantity, for example, a group with a quantity of persons more than 50000.

In some embodiments, thresholds (the first quantity and the second quantity) corresponding to the small group, the big group, and the super big group may be configured and adjusted according to an actual application requirement.

To better understand and illustrate the method provided by some embodiments, exemplary implementations of the method provided by this application will be illustrated below in combination with a specific scenario embodiment. In this scenario embodiment, an instant messaging application is used as an example for description. Besides a group interaction function, the instant messaging application may further integrate other functions (for example, including but not limited to data management, storage, and the like). This scenario embodiment will be illustrated in detail in twos aspects of group member information inquiry and group message transmitting.

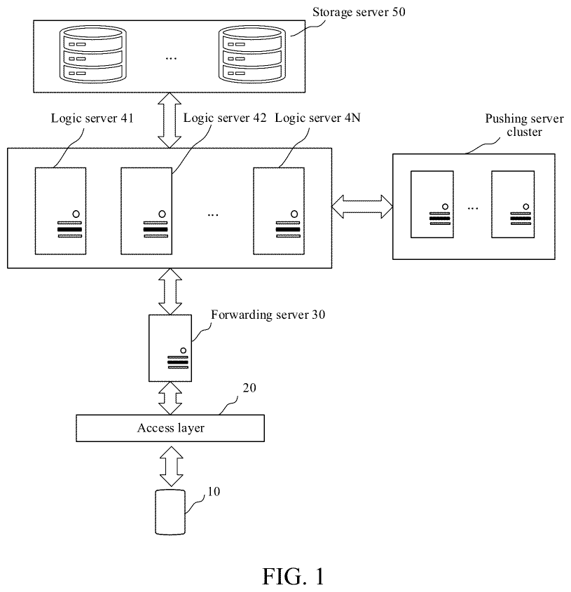

FIG. 1 is a schematic structural diagram of an exemplary data processing system according to some embodiments. As shown in FIG. 1, the data processing system may include: a user terminal 10, an access layer 20, a forwarding server 30 of a group forwarding layer, a plurality of logic servers (for example, a logical server 41, a logical server 42, . . . , and a logical server 4N) of a group logic layer, a storage server 50, and a pushing server cluster.

The user terminal 10 may be any one terminal having an application/software with an instant messaging function running therein. The user terminal may be a mobile phone of a user, a computer, or the like. The user terminal 10 may establish communication connection with a server of the instant messaging application through the access layer 20. A user may use various services provided by the application based on a user interface of the application displayed on the user terminal 10. For example, in a case that the user is a member in a group, the user may perform mass transmitting of a message. In the embodiments of this application, the user terminal 10 may access the forwarding server 30 of the instant messaging application through the access layer 20. The quantity of the forwarding server 30 may be one or more, and the access layer 20 may transmit, according to a preconfigured forwarding strategy, a service processing request of the user terminal 10 to the forwarding server 30 corresponding to the user terminal 10. The forwarding server 30 communicates with the logic servers of the instant messaging application. The logic servers may process a received service processing request. In this scenario embodiment, the storage server 50 may be a cloud server cluster, and may be configured to store various data involved in the instant messaging application, for example, including but not limited to basic group data of each group (such as a group identifier, time validity information (a validity period) of the group, group owner information of the group, an upper member limit of the group, a creation time of the group, and an identifier of each member in the group), and member data in the group (may include but not be limited to basic member data such as a member identifier, the time when a member joins the group, personal attribute information of a member, and may further include a current state of a member, for example, whether the member is online or not). In the embodiments of this application, the basic group data of the group and the member data of the members in the group may be separately stored, for example, stored in different server clusters. In some embodiments, the basic member data and the state information of the members may also be separately stored.

The forwarding server in this scenario embodiment is a first service node in some embodiments, and the logic server is a second service node. In some embodiments, the first service node and/or the second service node may be a cloud server. The pushing server in the pushing server cluster may push a mass transmitting message in the group.

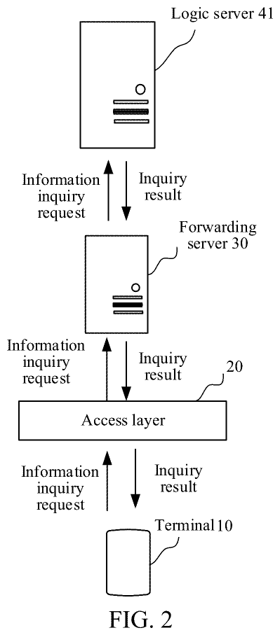

In some embodiments, any one member of any one group may inquire basic data of any one member in the group, or may inquire basic group data of the group. A solution of inquiring basic data of a group member according to some embodiments will be illustrated below with reference to FIG. 2. This solution is illustrated by taking a flow process of inquiring basic data of a member b in a group by a member a in the group as an example, and the inquiry flow process may include the following operations:

Operation S11: The user terminal 10 of the member a receives a basic member data inquiry operation.

In some embodiments, the member a may perform a set operation on a user interface of the user terminal 10 of the member a to initiate an inquiry request for the basic data of the member b. For example, the user interface may display a group member list of a target group to which the member a and the member b belong, identification information (such as a member nickname) of each member in the group may be displayed in the list, the member a may perform a click/tap operation (certainly may be in another triggering manner) in a target area (such as a display area of a name (such as a nickname or a memo name) of the member b in the user interface) associated with the member b, at this moment, various optional operations, such as “See Details” or “Transmit a Message”, associated with the member b may be displayed on the user interface, and the member a may trigger a basic data inquiry operation aiming at the member b by clicking/tapping “See Details”.

Operation S12: The user terminal 10 transmits a basic member data inquiry request (an information inquiry request in FIG. 2) aiming at the member b to the forwarding server 30, i.e., a group forwarding layer, through the access layer 20.

The basic member data inquiry request includes a first group identifier of the target group and a member identifier of the member b. The member identifier of the member b may be the name (for example, the nickname) of the member b in the target group, or may be a first member identifier (OriginUserID) of the member b, for example, a unique identifier (such as an allocated unique index of a member in a group according to a chronological order of group members joining the group, for example, a first member identifier of a member creating a group is 1, a first member identifier of a second member joining the group is 2, and so on, and a group identifier and one first member identifier may uniquely identify one member in the group) allocated to the member b when the member b joins the target group. In a case that the data inquiry request does not include the first member identifier of the member b, the logic server receiving the request may determine the first member identifier of the member b according to another member identifier of the member b carried in the request. For example, the logic server stores a mapping relationship between a nickname of each member in the group and the corresponding first member identifier, and the first member identifier of the member b in the group may be determined according to the mapping relationship. Therefore, for short, the basic member data inquiry request includes the first member identifier of the member b.

Operation S13: The forwarding server 30 determines, according to the first group identifier in the basic data inquiry request, a target logic server, i.e., a target group logic layer, corresponding to the request, and transmits the request to the target group logic layer, such as the logic server 41 as shown in FIG. 2.

After receiving the basic data inquiry request aiming at the member b, the forwarding server 30 may determine, according to the first group identifier carried in the request, the target logic server processing the request from a plurality of logic servers of the group logic layer. Each of the plurality of logic servers of the group logic layer may be associated with the first group identifier(s) of one or more groups. The first group identifier of one group is associated with a set quantity of logic servers in the plurality of logic servers. The set quantity herein may be one or more, and the set quantity is less than a total quantity of all logic servers in the group logic layer.

In some embodiments, an association relationship between the first group identifier of the group and the group logic layer may be established by using a consistent hash algorithm. In some embodiments, supposed that the total quantity of the logic servers in the group logic layer is ten, and the set quantity is three. For each logic server, a specified parameter of the logic server (for example, a node number or another identifier of the logic server) may be used for determining a first position of the logic server on a hash ring through a hash algorithm. For any one group, a second position of the group on the hash ring may be determined according to the first group identifier of the group through the hash algorithm. Then, according to a matching degree (for example, a distance, the matching degree is higher if the distance is shorter; or, by using the second position as an initial position, motion is performed on the hash ring in a clockwise and/or anticlockwise direction, the sequential order of passing through the first position is used as the matching degree, and the matching degree of the previously passed first position is higher) between the second position and the first position corresponding to each logic server, the logic servers corresponding to three first positions with the first position best matched with the second position among the ten logic servers are determined to be the target logic servers corresponding to the group.

Operation S14: The target logic server 41 processes the received basic member data inquiry request, and transmits the basic member data of the member b (i.e., an inquiry result) to the user terminal of the member a.

As shown in FIG. 2, suppose that the target logic server is the logic server 41 in FIG. 1, after receiving the basic member data inquiry request, the server may acquire the basic member data of the member b according to the first group identifier and the first member identifier of the member b carried in the request, and transmit the data to the user terminal 10 of the member a sequentially through the forwarding server 30 and the access layer 20, and the user terminal 10 displays the basic data of the member b to the member a.

In some embodiments, most or all service processing requests aiming at the group need to use the basic group data of the group, for example, the basic member data inquiry request also needs relevant verification based on the basic group data of the target group corresponding to the request, such as verification on whether the target group is invalidated or not, and whether the member b targeted by the request belongs to the target group or still in the target group or not. In consideration of this reason, in some embodiments, each logic server may be associated with one or more groups (i.e., the first group identifier), and each logic server may acquire the basic group data of the associated group from the storage server 50 in advance and cache the same. Of course, full update or incremental update may also be performed on the cached basic group data according to a preconfigured basic group data update strategy. Therefore, when one logic server receives the service processing request, the service processing request may be fast processed based on the cached group data. Each group may be only associated with some logic servers, therefore, according to the method provided in the embodiments of this application, basic group data of all groups does not need to be cached in all the logic servers, a cache utilization rate may be improved, and storage resource waste may be avoided.

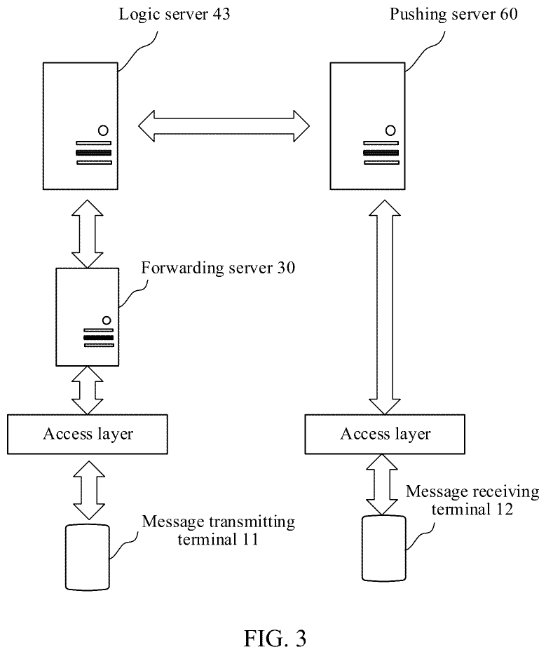

An exemplary flow process of a message mass transmitting solution aiming at a group according to some embodiments will be illustrated below in combination with an architecture shown in FIG. 3 and the above scenario embodiment. As shown in FIG. 3, a message transmitting terminal 11 is a user terminal transmitting a target message (a mass transmitting message) in a target group, and a message receiving terminal 12 is a user terminal of any one member in the target group. By taking the transmitting terminal 11 being a user terminal of a member a in the target group (which may be any one group), and the receiving terminal 12 being a user terminal of a member b as an example, a message mass transmitting flow process may include the following operations:

Operation S21: The transmitting terminal 11 receives a message mass transmitting operation of the member a aiming at the target group.

Operation S22: The transmitting terminal 11 transmits a message mass transmitting request to a forwarding server 30 through an access layer.

In some embodiments, the member a may input a message to be transmitted in a mass transmitting manner onto a message mass transmitting interface of an instant messaging application on the transmitting terminal 11, and a “Transmit” control may be clicked/tapped after the input. After acquiring the click/tap operation of the member a, the transmitting terminal 11 may transmit the message mass transmitting request to the forwarding server 30 through the access layer, and the request includes a mass transmitting message to be transmitted and a first group identifier of the target group.

Operation S23: The forwarding server 30 determines, according to the first group identifier in the massage mass transmitting request, a target logic server corresponding to the request, and transmits the request to the target logic server, such as the logic server 43 in FIG. 3.

Operation S24: The target logic server 43 determines a member quantity corresponding to the target group according to the first group identifier in the message mass transmitting request, and determines whether the target group is a small group, a big group, or a super big group according to the member quantity.

Operation S241: In a case that the target group is the small group, the target logic server 43 reads member data of all members in the target group from a local cache or acquires the member data of all the members in the target group from a storage server 50 according to the first group identifier of the target group, generates to-be-pushed information aiming at each member, and transmits the information to a message center.

Operation S242: In a case that the target group is the big group, the target logic server 43 generates to-be-pushed information corresponding to the target group according to the first group identifier of the target group, and transmits the to-be-pushed information to a message queue to be stored, and the to-be-pushed information includes group indication information (for example, the first group identifier) and the target message.

Operation S243: In a case that the target group is the super big group, the target logic server 43 determines a subgroup quantity of the target group according to the member quantity of the target group, generates a subgroup index of the corresponding quantity, generates to-be-pushed information corresponding to each subgroup index based on each subgroup index, and transmits the to-be-pushed information into the message queue to be stored, and the to-be-pushed information includes group indication information (for example, the first group identifier and the subgroup index) and the target information.

In some embodiments, the small group, the big group, and the super big group are divided according to the member quantity in the groups. Member person division thresholds of different groups may be configured and adjusted according to an actual requirement.

Operation S25: A pushing server 60 consumes the to-be-pushed information in the message center or the message queue, and pushes the target message to each member in the group.

To better satisfy a pushing requirement of the mass transmitting message in an actual application and improve push efficiency, two message push modes are provided in the embodiments of this application. One mode is a fast-channel pushing mode aiming at the small group, and the other mode is a slow-channel pushing mode aiming at the big group and the super big group.

In some embodiments, in a case that the target group is a small group, the member quantity is relatively small, and the target logic server may generate to-be-pushed information corresponding to each member based on the member data of each member in the target group. Of course, in a case that the target logic server previously acquires and caches the member data of each member in the target group, the target logic server may directly read the member data of each member in the target group from a cache, and generate the to-be-pushed information corresponding to each member according to the member data of each member, the to-be-pushed information corresponding to each member may be stored into the message center, and the to-be-pushed information stored in the message center is consumed by the pushing server. In a case that no cached member data exists in the target logic server, the logic server may acquire the member data from the storage server.

In a case that the target group is a big group or a super big group, by still using a fast-channel pushing mode, the processing time of the target logic server may be greatly increased. For this problem, a slow-channel pushing mode may be adopted for the big group and the super big group. For the big group, the target logic server may generate the to-be-pushed information based on the first group identifier of the target group. In some embodiments, the to-be-pushed information may include the first group identifier and a target message (i.e., a mass transmitting message) needing to be pushed. The to-be-pushed information may be stored in the message queue to be consumed by the pushing server. During consumption of the to-be-pushed information, the pushing server may acquire member data of each member corresponding to the first group identifier from a cache thereof or the storage server based on the first group identifier. Based on the member data of each member, the target message may be pushed to each member in an online or offline pushing mode.

For the super big group, the target logic server may divide the target group into a plurality of subgroups according to the specific member quantity of the target group, each subgroup may correspond to some members in the target group, the target logic server may generate to-be-pushed information corresponding to each subgroup, and store the to-be-pushed information corresponding to each subgroup into the message queue to be consumed by the pushing server. At this moment, the to-be-pushed information corresponding to one subgroup further needs to include group indication information corresponding to the subgroup besides the target message to be pushed. The pushing server may acquire member data of each member in the some members corresponding to the subgroup from the storage server or the cache thereof based on the indication information, so that the target message may be pushed to each member corresponding to the subgroup in an offline or online pushing manner. The indication information in the to-be-pushed information corresponding to each subgroup may be determined by a specific storage mode of the member data of the group members. For example, the member data may be acquired according to the group identifier and the subgroup index of the target group in accordance with the storage mode of the member data, and the indication information may be the group identifier and the subgroup index.

That is, group indication information corresponding to the big group is configured for determining relevant information of all members in the whole group, and group indication information corresponding to the super big group is configured for determining relevant information of members corresponding to one subgroup in the group.

In some embodiments, pushing servers or server clusters corresponding to the fast-channel pushing and the slow-channel pushing may be the same or may be different. As shown in FIG. 3, when the pushing server 60 consumes the to-be-pushed information in the message center, the to-be-pushed information in the message center corresponds to each member, and at least includes information such as a member state (online or not) and a pushing address of a member, and the pushing server 60 may transmit the target message to a user terminal of each member according to the information. In some embodiments, the pushing server 60 may transmit the target message to the message receiving terminal 12 through the access layer. For the to-be-pushed message in the message queue, the message queue includes indication information for acquiring the member data, so when consuming the to-be-pushed information in the message queue, the pushing server 60 needs to firstly acquire member data from the cache thereof or the storage server based on the indication information in the to-be-pushed information, and then push the target message based on the acquired member data.

The exemplary storage modes of the basic group data of the group and the basic data of the members in the group and the data acquiring modes in some embodiments will be further illustrated below in combination with exemplary implementations.

The technical solutions of some embodiments and technical effects achieved by the technical solutions will be illustrated below through description on some exemplary implementations. The following implementations may refer to, pertain to, or be combined with each other on the premise of no conflict among them. The same terms, similar features, similar implementation operations, and the like in different implementations are not repeated.

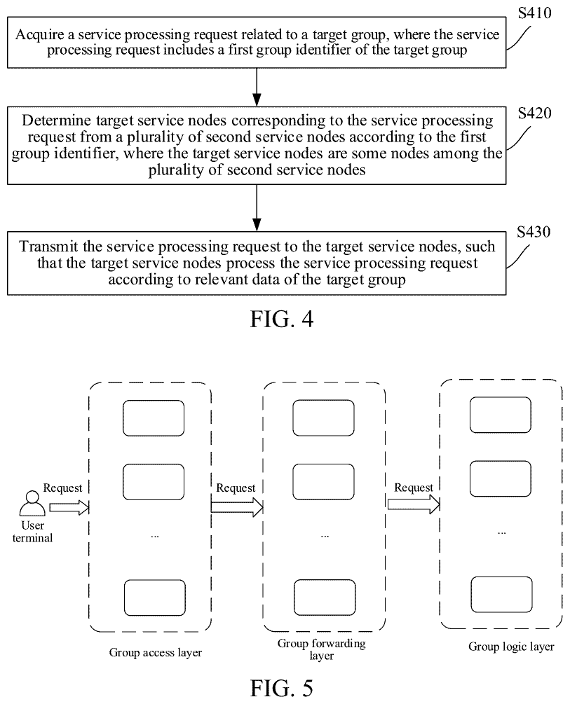

FIG. 4 shows a schematic flow chart of a data processing method according to some embodiments. The method may be implemented by a first service node (such as the forwarding server in FIG. 1). As shown in FIG. 4, the data processing method provided by some embodiments may include the following operations:

Operation S410: Acquire a service processing request related to a target group from an access layer, where the service processing request includes a first group identifier of the target group.

Operation S420: Determine target service nodes corresponding to the service processing request from a plurality of second service nodes in a group logic layer according to the first group identifier. The target service nodes are some nodes among the plurality of second service nodes. In an implementation, the target service nodes may cache basic group data of the target group.

Operation S430: Transmit the service processing request to the target service nodes, such that the target service nodes process the service processing request according to relevant data of the target group. The relevant data may include the basic group data of the target group. For example, in an implementation, the target service nodes may determine a member size of the target group according to the basic group data of the target group and process the service processing request according to the member size of the target group.

The target group may be any one group (or directly referred to as a group) in a target application program, such as a group in an instant messaging application, and one group needs to include at least one member. A specific request type of the service processing request is not limited in the embodiments of this application, and it may be any one service processing request aiming at the target group. For example, the service processing request may be a group member data inquiry request, a group data inquiry request, a message mass transmitting request, and the like.

In some embodiments, the first group identifier of the target group may be referred to as an original group identifier or an original group code (OriginGroupCode) of the target group. A determining mode of the original group code is not limited in the embodiments of this application, and it may be a number or in another mode. A group code of a group may uniquely identify the group.

In some embodiments, one group may be associated with at least one second service node (such as the logic server in FIG. 1), and the at least one second service node is some nodes among all second service nodes. A service processing request aiming at one group may be transmitted by the first service node to the second service node associated with the group, and a service processing logic preset in the second service node processes the service processing request.

For description convenience, in some embodiments below, the first service node may be referred to as the group forwarding layer, and the second service node may be referred to as the group logic layer.

In some embodiments, an association between the group and the associated group logic layer thereof may be established through the original group code of the group. After receiving the service processing request, the group forwarding layer may determine the group logic layer, i.e., the target service node, corresponding to the request according to the original group code carried in the request. A specific mode of establishing the association between the group and the second service node through the original group code is not uniquely limited herein, and it may include but is not limited to a consistent hash algorithm.

In some embodiments, for the above target group, after receiving the service processing request aiming at the group, the group forwarding layer may use the OriginGroupCode of the group as a key, and forward the request to one or several group logic servers among the plurality of group logic servers in the group logic layer through the consistent Hash. The one or several group logic servers herein are the target service node(s) corresponding to the service processing request. In some embodiments, for a service processing request aiming the target group from any one user terminal, the group forwarding layer may transmit the service processing request to a group logic server with a light load according to a load condition of each group logic layer corresponding to the target group.

FIG. 5 shows an exemplary processing flow process of a service processing request according to some embodiments. By taking a service processing request aiming at a group-related request of a target group as an example, the request processing flow process may include: a user terminal may initiate the group-related request through a client of an instant messaging application on the terminal. The group-related request reaches an access layer. The access layer may transmit the group-related request to a group forwarding layer. The group forwarding layer determines a target group logic layer associated with the target group according to an original group code of the target group, and forwards the group-related request to the target group logic layer for processing. For example, the group-related request is a basic group data inquiry request. After receiving the basic group data inquiry request, the target group logic layer may find the basic group data of the target group according to the group code, and transmit the basic group data to the group forwarding layer. The group forwarding layer transmits the basic group data to the requesting user terminal through the access layer, and the user terminal displays the basic group data to the user.

In some embodiments, target service nodes of the target group may cache the basic group data of the target group, and second service nodes other than the target service nodes do not cache the basic group data of the target group. When processing the received service processing request, the target service nodes may perform processing based on relevant data of the target group. The relevant data includes the basic group data of the target group.

In some embodiments, at an application program initialization stage, in a case that a group logic layer associated with a group does not cache basic group data of the group, the group logic layer may firstly acquire the basic group data of the group from a storage server storing the basic group data and cache the basic group data according to an original group code of the group when receiving a service processing request corresponding to the group. In some embodiments, data caching in the group logic layer may be short-time caching. For example, cached data may be deleted after a caching duration exceeds a set time (for example, 2 seconds), so that occupation on storage resources of the group logic layer may be reduced. When receiving the service processing request again, the group logic layer may pull the relevant data again from the storage server of the basic group data. Of course, if a storage capability of the group logic layer is sufficiently strong, theoretically, the group logic layer may also regularly update the cached basic group data. For example, the group logic layer may regularly request updated basic group data from the storage server, or the storage server may transmit the updated data to the group logic server associated with the group in a case that there is update of the basic group data of the group. The update may be full update, or may be incremental update.

For an application (such as instant messaging IM software) providing a service related to groups, there are generally two pieces of main data (relevant data of a group), one piece is basic group data, and the other piece is basic group member data. Most requests related to the group need to perform verification on these two pieces of data (for example, whether the group exists or not, or whether the members are all members of the whole group or not, or whether a requesting end has a permission or not in a case that the request relates to verification of permission). For the group, generally, the group may stably operate in a case that the group is a small group. However, in a case that the quantity of group members reaches a certain number (for example, reaching a level of ten thousand), the quantity of group members is relatively large, and the quantity of requests aiming at the same group will be great, so a request hotspot problem may be easily caused, and a server may be easily crashed by a great number of requests aiming at the same group.

The basic group member data is related to the group members, so there is no hotspot problem generally. A problem of the great quantity of requests related to the group member data may be resolved in a distributed storage mode. It is unnecessary for the basic group data. All the group members use the same basic group data, the basic group data may be updated under conditions of group join-in or exit of group members, message transmitting in the group, and the like. The basic group data may also be read under conditions of application login of group members, application switching from a background to a foreground, and message reading by group members, and the like. The group may involve with a large number of concurrent read operations of the basic group data. The use of general distributed storage without special processing may easily cause resource imbalance. For example, basic group data of a group with a million of members is stored in a machine in a distributed mode. To match a large number of read requests, a configuration of the storage machine needs to be adjusted to be very high, or a large number of copies need to be started to deal with the read requests. In such a way, configuration of other distributed storage machines which do not store the group with a million of members is correspondingly increased, and resource waste is caused. In some embodiments, to reasonably use resources, a local cache may be added at the group logic layer, that is, the basic group data is cached at the group logic layer. However, in the current related art, according to a group request processing mode of the related art as shown in FIG. 6, when receiving a group-related request of a user terminal, the access layer may forward the group-related request to the group logic layer, for example, the group logic layer with a small load determined based on a load balance strategy. At present, a request of one group may be transmitted to any one group logic layer. In a case of using a mode of adding a local cache in the group logic layer, all machines in the group logic layer need to cache basic group data of all groups, so that a cache utilization rate after the addition of the local cache is not high.

To avoid a hotspot request problem and improve the utilization rate of the storage resource, in a data processing method provided by some embodiments, a group forwarding layer, i.e., the above first service node, is added. In addition, each group is only associated with some machines in the logic layer, i.e., some second service nodes, and each second service node may be associated with one or more groups (in some embodiments, may be some groups). Therefore, each second service node may only need to cache the basic group data of the group associated with the second service node, and does not need to cache the basic group data of other unassociated groups. Correspondingly, when receiving a service processing request related to a group, the group forwarding layer only needs to forward the request to the group logic layer associated with the group. By adding the local cache at the group logic layer, acquisition efficiency of the basic group data may be greatly improved, and a hotspot problem caused by a large quantity of requests aiming at the same group may be avoided. By adding the group forwarding layer and establishing the association between the group and some group logic layers associated with the group, relevant requests of the same group may only be processed by some group logic layers associated with the group, and relevant data of the group only needs to be cached in some group logic layers, so that the cache utilization rate may be effectively improved, and resource waste may also be avoided.

The member data of each member in the target group may include at least one of basic member data or member state information. The basic member data may include but is not limited to basic information such as a member nickname, a member profile picture, group join-in time of members, and member types (for example, whether the member is a group creator or a group administrator or not) of the members in the group. The member state information refers to whether a member is currently in an online state or an offline state. The basic member data and the member state information of the group members may be stored by using the same storage server cluster, or may be stored by using different storage server clusters. In some embodiments, the basic member data of each member in the target group may be stored in a basic data storage server, and the member state information may be stored in a state storage server.

In the current related art, for one group, the member data of the group members of the group is generally stored in a distributed mode according to the group code (for example, GroupCode). For example, by using the group code as the key to calculate the storage server corresponding to the group, the member data of all members in the group is totally stored into the storage server. For example, the data is stored into the storage server based on a first member identifier of the member. Then, with a continuous increase of the quantity of the group members, resource requirements on some machines storing the group with millions of members will be high. Therefore, configurations of all group storage machines need to be uniformly upgraded, and resource waste is caused.

To solve or relieve the problems caused by data storage of group members, in some embodiments, the member data of each member in the target group may be stored in the following mode:
acquire a second member identifier of each member in the target group.

For any one member in the target group, a second target storage node corresponding to the member is determined from a plurality of second storage nodes according to the second member identifier of the member, and the member data of the member is stored in the second target storage node.

Some embodiments provide a solution for performing split storage on relevant data of the group members instead of storing relevant data of all members in one group into one server. The second member identifier of one member is information capable of uniquely identifying the member. The second member identifier of each member in one group may be acquired according to a preconfigured identifier generation rule, and the second member identifier may be referred to as a MemberId.

For each member in the target group, the second member identifier of the member may be used as a storage basis, and the second target storage node (such as a cloud server or a server of another type) storing the member data of the member is determined according to the identifier. In some embodiments, the member data of the member may be stored in a target node based on the second member identifier. That is, the storage node in which the member data is stored may be determined according to the second member identifier, and the member data of the member may be read from the corresponding storage node according to the second member identifier.

A specific implementation of determining the second target storage node corresponding to the member according to the second member identifier of the member is not uniquely limited herein. In some embodiments, it may be any mode capable of establishing an association relationship between the second member identifier and the second target storage node corresponding to the identifier. In some embodiments, for any one member, the second member identifier of the member may be used as an index for retrieving the member data. When the member data of the member needs to be acquired, the member data of the member may be directly retrieved from the local cache based on the index, or the second target storage node corresponding to the member may be found based on the index, or the member data of the member may be read from the second target storage node according to the index.

In some embodiments, acquiring the second member identifier of each member in the target group may include:
determine a member quantity of the target group;
generate the second member identifier of each member in the target group in a case that the member quantity is greater than or equal to a first threshold, record and store a mapping relationship between an old identifier and the second member identifier of each member, and the old identifier of one member includes a first member identifier of the member and a first group identifier of the target group; and
store the member data of each member in the target group in the following modes in a case that the member quantity is smaller than the first threshold:
determine a first target storage node corresponding to the target group from a plurality of first storage nodes according to the first group identifier; and
store the member data of each member in the target group into the first target storage node based on the first member identifier of each member in the target group.

In some embodiments, the storage mode of the member data may be determined according to the member quantity of the group at present. In a case that the member quantity of the group is small, i.e., in a case that the member quantity of the group is smaller than the first threshold, the distributed storage mode on the group member data according to the group code may still be used. When the member quantity of the group exceeds a certain number, the group member data is migrated from the first target storage node to the second target storage node.

A specific value of the first threshold may be configured and adjusted according to an actual application requirement. For description convenience, in the embodiments of this application, a group with a member quantity greater than or equal to the first threshold may be referred to as a super big group, and a group with a member quantity smaller than the first threshold may be referred to as a non-super-big group. The non-super-big group may be a small group or a big group. In some embodiments, the big group and the small group may be divided by using a second threshold, a group with a member quantity greater than or equal to the second threshold may be referred to as a big group, and a group with a member quantity smaller than the second threshold may be referred to as a small group.

In some embodiments, for the non-super-big group, the members in the group may only have the first member identifier (may be referred to as an original member identifier OriginUserId), and a specific generation mode of the identifier may also be configured according to requirements. For example, it may be a number code. For example, the code may be increased from 1 according to the group join-in time of the member. When the group reaches a size of the super big group, a new group code (NewGroupCode, i.e., a second group identifier below) may be allocated to the group, and a generation mode of the new group code may also be configured according to an actual application requirement. For example, the code may be increased from 1, a new group code of the first migrated group is 1, and a new group code of the second migrated group is 2.

When the group reaches a size of the super big group, the second member identifier, i.e., a member identifier needing to be used during member data acquisition, may be generated for each member in the group. As an exemplary solution, for any one member in the target group, the second member identifier of the member may be generated in the following mode:
determine the second group identifier of the target group and a third member identifier of the member;
determine a target shard index corresponding to the member according to the first member identifier of the member and a total quantity of shards corresponding to the plurality of second storage nodes; and
generate the second member identifier of the member based on the second group identifier, the target shard index of the member, and the third member identifier.

In some embodiments, the member data of the member in the target group may use a distributed storage solution of data shards. The total quantity of shards corresponding to the plurality of second storage nodes may be preconfigured according to an actual requirement, and each second storage node may correspond to at least one shard. By using a data shard mode, the data inquiry efficiency may be further accelerated. In the embodiments of this application, the second member identifier MemberId of the member may be used as a shard key for distributed storage. Each shard has a respective shard index (ShardIndex). One shard index uniquely identifies one shard. For any one member in any one group, the member data of the member may correspond to one shard.

The third member identifier (may be referred to as NewUserId) of one member may be a new member code allocated to the member when the member quantity increases to the super big group. For each group, the code of each member in the group may increase from 1. For example, a code may be sequentially allocated to each member in the group from 1 according to a target group join-in time (or not according to the target group join-in time) of the member, and a third member identifier of an n^{th} member is n.

In some embodiments, the target shard index corresponding to one member may be determined based on the first member identifier OriginUserId of the member and the total quantity of shards, and the OriginUserId of one member in the group is associated with one shard. In some embodiments, the first member identifier may be a number. For example, there are totally m members in the group, and a first member identifier of a j^{th} member is j. The shard indexes of all the shards corresponding to the plurality of second storage nodes may also be numbers. For example, the total quantity of the shards is 256, and a shard index of an i^{th} shard is i−1. A calculation result of an OriginUserId % 256 of one member may be determined as the target shard index of the member, or referred to as a target shard digit.

After the target shard index corresponding to the member is determined, the second member identifier of the member may be generated based on the second group identifier of the group, the target shard index corresponding to the member and the third member identifier NewUserId of the member. The method is used for generating the second member identifier, on one hand, simplicity and easy implementation are realized, and on the other hand, the second group identifier and the third member identifier may ensure the uniqueness of the second member identifier. In addition, through the target shard index and the third member identifier, the second member identifier may have interval performance, and is convenient to search. In the embodiments of this application, under the condition that a group is determined, the first member identifier and the third member identifier of the member may be unique identifiers of the member in the group (i.e., an identifier in the group, and a local identifier of the member). A combination of the first group identifier of the group and the first member identifier of the member, or a combination of the second group identifier of the group and the third member identifier of the member (a unique identifier between groups and a global identifier of the member) may uniquely identify one member in one group. Through a combination of the second group identifier of the group, the third member identifier of the member, and the target shard index corresponding to the member, the second target storage node in which the member data is stored may be found from the plurality of shards, or the member data of the member may be acquired from the second target storage node.

In some embodiments, the second group identifiers of different groups may use continuous digital codes as group identifiers, and the third member identifier of each member in the target group may also use continuous digital codes. For any one member, the second member identifier of the member may be a binary code identifier, i.e., a binary code. In a descending order, the binary code identifier corresponding to the member may include: a binary representation of a first set digit corresponding to the second group identifier of the target group, a binary representation of a second set digit corresponding to the target shard index of the member, and a binary representation of a third set digit corresponding to the third member identifier of the member. In this embodiment, the second member identifier is represented by using a binary system, and it may be conveniently read by a machine.

The first set digit, the second set digit, and the third set digit may be preconfigured according to an actual application requirement. The second set digit is a number of bits occupied by the binary representation of the total quantity of the shards. For example, the total quantity of the shards is 256, and the second set digit is 8. The third member identifiers NewUserId in the target group may be sequentially ascending from 1, and the shard indexes of all shards may be sequentially ascending from 0. Therefore, a shard index with the binary representation being 00000000 indicates a first shard index, and a shard index with the binary representation being 00000001 indicates a second shard index.

In some embodiments, the first set digit may be 28 bits, the second set digit may be 8 bits, and the third set digit may be 28 bits. In this case, a second member identifier MemberId (also referred to as a member data ID) of each member in the group may be represented as follows:

| NewGroupCode | ShardIndex | NewUserId |
|---|---|---|
| (28 bits) | (8 bits) | (28 bits) |

The high 28 bits of the second member identifier are NewGroupCode (i.e., the binary representation of the new group code), the low 28 bits are NewUserId, and the middle 8 bits are ShardIndex of the shard bits. They may be subjected to OriginUserId % 256 calculation. The OriginUserId may be 64-bit integer data.

After the second member identifier MemberId of each group member is generated, the MemberId of each member may be used as a shard key to migrate the member data of the member to a new storage node. Specifically, the second storage node in which the member is located may be determined according to MemberId, and the member data is stored into the second storage node.

To retrieve the member data according to the first member identifier OriginUserId of the member, during generation of the second member identifier for the member, an index layer, Member Index (MIndex), needs to be newly added, and is configured for storing a mapping relationship from OriginGroupCode and OriginUserId to MemberId, that is, the mapping relationship between the old identifier of the member and the second member identifier of the member are recorded and stored. The old identifier of the member may be associated with the OriginUserId of the member. In some embodiments, the old identifier of the member may be a global identifier of the member. For any one member in the target group, the old identifier of the member may include the first member identifier of the member and the first group identifier. When data of a member needs to be acquired, the second member identifier MemberId of the member may be found according to the first member identifier of the member and the first group identifier, and then, the member data of the member may be acquired from the second storage node by using the MemberId.

Corresponding to the storage solution of the group member data provided in the embodiments of this application, the member data of the members in the target group may be acquired in a corresponding mode. In some embodiments, for any one member in the target group, the member data of the member may be acquired in the following mode:
determine a member quantity of the target group;
determine, in a case that the member quantity is smaller than the first threshold, the first target storage node corresponding to the target group based on the first group identifier, and acquire the member data of the member from the first target storage node based on the first member identifier of the member; and use a conventional member data storage and extraction solution for maintaining the system compatibility.

In a case that the member quantity is greater than or equal to the first threshold, the second member identifier of the member is determined according to the old identifier of the member and the mapping relationship, the second target storage node corresponding to the member is determined according to the second member identifier of the member, and the member data of the member is acquired from the determined second target storage node.

In some embodiments, in a case that the member quantity is small (for example, the group is a small group or a big group), storage is still performed in an original mode, for example, the OriginGroupCode may be used for shards, one group member may be retrieved by using OriginGroupCode and OriginUserId, and a storage position, i.e., the first target storage node, of the member data of all members in the target group may be determined according to OriginGroupCode. Further, the member data of each member may be retrieved from the second target storage node according to the OriginUserId (or OriginGroupCode and OriginUserId) of each member. For example, for the storage node of the group member data of one group, in a case that the member data of different groups is separately stored, an electronic device (for example, the second service node or a mass message transmitting pushing server) requesting the member data may request the member data according to OriginGroupCode and OriginUserId. Of course, in a case of requesting data of all members in the group, the requesting may be performed according to OriginGroupCode. After receiving the request, the storage node may find the data of all members in the group according to OriginGroupCode. In a case of requesting data of a member, the storage node may find the member data of the member from data of all members in the group according to OriginUserId of the member.

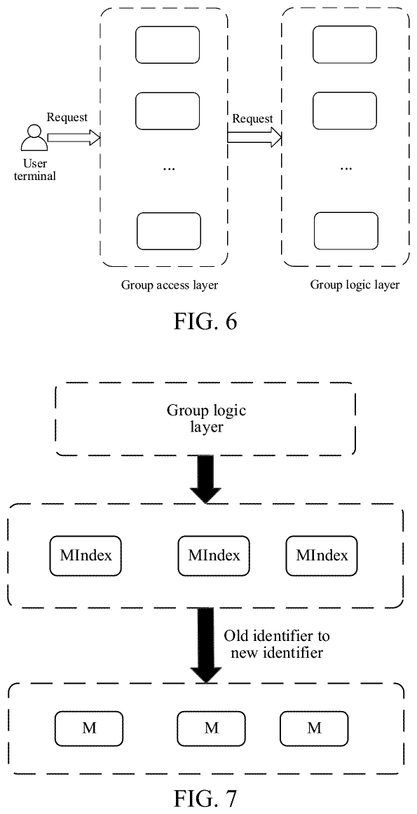

In a case that the target group is a super big group, the second member identifier MemberId of the member in the group needs to be firstly determined according to the mapping relationship, and then, the member data is retrieved according to the MemberId. FIG. 7 shows a schematic principle diagram of member data retrieval of group members of a super big group. For example, a service processing request transmitted by a user terminal is a basic data acquiring request of a member a, and the service processing request includes an original group code OriginGroupCode of a target group and a first member identifier OriginUserId of the member a. After a target service node, i.e., a target group logic layer corresponding to the target group receives the service processing request transmitted by a group forwarding layer, a member quantity of the target group may be firstly determined. For example, the member quantity may be determined according to basic group data. In a case that the target group is a super big group, the target group logic layer finds MemberId (new UserID) of the member a from a mapping relationship (such as MIndex as shown in FIG. 7) between MemberId and an old identifier of a member according to OriginGroupCode and OriginUserId (original UserId) in the service processing request, and the member data of the member a may be acquired through retrieval according to the MemberId.

According to the above storage solution provided by some embodiments, after migration, group members of the super big group (for example, a group with a million of members) may be converted from the use of original GroupCode shards to the use of new MemberId shards, so that the quantity of shard keys may be greatly increased, and data of group members of the group with a million of members may be dispersed to a plurality of storage machines by using distributed storage. The storage resources are balanced, data accumulation of all group members of one group on one machine may be avoided, and a bottleneck problem generally met during pagination pulling of group member information or full pulling of group member information may be solved. In some embodiments, the migration operation of the group member data may be performed by the logic layer, or may be performed by a migration server. In some embodiments, to avoid the influence on the service processing of the group logic layer, asynchronous migration may be adopted for the migration of the group member data. For example, in a case that the quantity of group members reaches a super big group size, the logic layer may notify the migration server to perform a migration operation on the group member data of the target group.

In some embodiments, the service processing request aiming at the target group may include a message mass transmitting request. The request includes a target message (the target message may include but is not limited to one or more of various modal information such as a text, an image, a voice, or a video) inputted by a transmitting terminal. The target message needs to be transmitted to each member in the target group. In some embodiments, for the mass transmitting of the target message of the target group, the group logic layer may generate to-be-pushed information respectively corresponding to each member based on member data, locally stored or acquired from the storage node, of all members in the target group. A pushing server consumes the to-be-pushed information of each member, and pushes the target message to each member, that is, the target message is transmitted to a user terminal of each member. For online group members, an online pushing mode may be adopted. For offline group members, an offline pushing mode may be adopted.

The above solution may satisfy a basic message mass transmitting requirement, but according to this solution, the logic layer needs to firstly find out member data of all group members in the group, and then determine to use online pushing or offline pushing according to the group member states. In a case that the member quantity of the target group reaches a certain value, if information of all group members is inquired for each time there is a mass transmitting message in the target group, a pushing delay of the mass transmitting message becomes unacceptable. To accelerate the message pushing speed, as an exemplary solution, a mode of firstly caching the group member information to a local area (for example, a local memory) and regularly updating the group member information may be adopted. Specifically, when message mass transmitting is needed, the member data of each member in the target group may be acquired in the following modes:
acquire the member data of each member in the target group from the local cache in a case that the member data of each member in the target group exists in the local cache; and
acquire the member data of each member in the target group from a target storage node (such as the first target storage node corresponding to the target group, or the second target storage node corresponding to the member in the target group) storing the member data of each member of the target group in a case that no member data of each member in the target group exists in the local cache, and cache the acquired member data in the local cache.

In a case that the group logic layer or the pushing server caches the member data, the cached data may be regularly updated or may be updated according to a notification. For example, the group logic layer or the pushing server may pull the latest group member data at a certain interval from the storage node of the member data, or the pushing server may pull the member data from the group logic layer.

In addition, for a target group with a great member quantity (for example, a big group and a super big group), in a case that there is a mass transmitting message aiming at the group each time, the target group logic layer corresponding to the target group generates to-be-pushed information corresponding to each member according to member data of each member. That is, for each member, the target group logic layer needs to tell the pushing server to push relevant information of the member and the mass transmitting message required by the message to the member, so the group logic needs lots of resources and a long processing time. In some embodiments, the target message needing to be transmitted in a mass transmitting mode is transmitted by the target service node in the following mode:
determine a member quantity of the target group;
acquire the member data of each member in the target group in a case that the member quantity is smaller than a third threshold (this threshold may be the same threshold as a second threshold or may be different threshold from the second threshold), and for each member in the target group, generate to-be-pushed information corresponding to the member and including the target message according to the member data of the member, so that a fourth pushing server pushes the target message to the member based on the to-be-pushed information; and
generate to-be-pushed information corresponding to the target group in a case that the member quantity is greater than or equal to the third threshold, so that a fifth pushing server acquires the member data of each member in the target group according to third group indication information in the to-be-pushed information, and pushes the target message in the to-be-pushed information to each member according to the member data of each member.

The fourth pushing server and the fifth pushing server may be servers in the same pushing server cluster, or may be servers in different pushing server clusters.

In some embodiments, two different solutions for pushing the mass transmitting message are provided. The pushing mode with the member quantity smaller than the third threshold (for example, a small group) may be referred to as fast-channel delivery, and the pushing mode with the member quantity greater than or equal to the third threshold (for example, a big group or a super big group) may be referred to as slow-channel delivery. The main difference between the two modes includes: for fast-channel delivery, the target group logic layer generates the to-be-pushed information of each member, and the pushing server only needs to transmit the target message to the corresponding member according to the relevant information of the member and the target message included in the to-be-pushed information. Besides the target message, the to-be-pushed information corresponding to the slow-channel delivery further includes third group indication information. The pushing server needs to voluntarily acquire, according to the third group indication information, relevant information of the member required for pushing the target information, such as relevant information of the member state (online or offline) and the user terminal of the member. The pushing server transmits, according to the acquired relevant information of each member, the target message to each member corresponding to the third group indication information in an offline pushing mode or an online pushing mode. Therefore, for a target group with the great member quantity (for example, a big group and a super big group), in a case that there is a mass transmitting message aiming at the group each time, the target service node corresponding to the target group does not need to generate to-be-pushed information corresponding to each member according to member data of each member. That is, for each member, the target group logic layer does not need to tell the pushing server to push the relevant information of the member and the mass transmitting message required by the message to the member, so lots of resources and much processing time may be saved for the group logic.

The specific contents of the group indication information (such as the above third group indication information, the first group indication information below, and the second group indication information) described in the embodiments of this application are not limited in the embodiments of this application, and the association may be realized in a mode of the group member information. Theoretically, as long as the pushing server may acquire the member data of each member needing to push the target message according to the group indication information, the member data herein may be relevant data required for message pushing.

In some embodiments, in a case that the member quantity is greater than or equal to the third threshold but is smaller than the first threshold, for example, the target group is a big group, the to-be-pushed information corresponding to the target group may be the to-be-pushed information corresponding to all members in the group, the third group indication information may include the first group identifier, the pushing server may acquire the member data of all members in the target group according to the first group identifier, and may push the target message to all members in the group based on the acquired member data. In a case that the member quantity is greater than the first threshold, for example, the target group is a super big group, the to-be-pushed information corresponding to the target group may include to-be-pushed information corresponding to a plurality of subgroups, each subgroup corresponds to some members in the group, the third group indication information may include the first group identifier and a subgroup indication (such as a subgroup index), for the to-be-pushed information corresponding to each subgroup, the pushing server may determine and acquire member data of some members corresponding to the subgroup according to the third group indication information in the information, and may push the target message in the to-be-pushed information to these members.

The fast-channel delivery pushing mode and the slow-channel delivery pushing mode provided by some embodiments may be applicable to a group member data storage mode in the related art, and may further be applicable to any one group member data storage mode provided by some embodiments. The pushing server may acquire the member data of each member in the group according to the group indication information in the to-be-pushed information when the slow-channel delivery solution is adopted.

According to some embodiments, the following storage mode may be adopted for the group member data of the target group:
determine the first target storage node corresponding to the target group based on the first group identifier in a case that the member quantity of the target group is smaller than the first threshold, and store the member data of each member into the first target storage node based on the first member identifier of each member; and adopt the solution of using a binary coded identifier as the second member identifier of each member provided in the above in a case that the member quantity is greater than or equal to the first threshold, determine the second target storage node of each member, and store the member information of each member into the corresponding second target storage node.

For this storage mode, in a case that the service processing request of the target group is a mass transmitting request of a target message, as an exemplary solution, the target message needing to be transmitted in a mass transmitting mode may be transmitted by the target service nodes in the following mode:
acquire the member data of each member in the target group based on the first group identifier in a case that the member quantity is smaller than the second threshold; generate, for each member, the to-be-pushed information corresponding to the member according to the member data of the member and the target message, so that a first pushing server pushes the target message to the member based on the to-be-pushed information corresponding to the member;
generate the to-be-pushed information corresponding to the target group in a case that the member quantity is greater than or equal to the second threshold but is smaller than the first threshold, so that a second pushing server acquires the member data of all members in the target group according to first group indication information in the to-be-pushed information, and pushes the target message in the to-be-pushed information to each member according to the member data of each member, that is, one group corresponds one piece of to-be-pushed information, where the second threshold is smaller than the first threshold;
determine a subgroup quantity corresponding to the target group according to the member quantity in a case that the member quantity is greater than or equal to the first threshold, and generate the corresponding quantity of subgroup indexes, where each of the subgroup indexes corresponds to some members in the target group, different subgroup indexes correspond to different members, and each of the subgroup indexes corresponds to at least one shard; and for each of the subgroup indexes, generate to-be-pushed information corresponding to the subgroup index based on the target message and the subgroup index, so that a third pushing server acquires the member data of each member corresponding to the subgroup index in the target group according to second group indication information in the to-be-pushed information, and pushes the target message in the to-be-pushed information corresponding to the subgroup index to each member according to the member data of each member.

In some embodiments, different groups may be divided into three types: a small group, a big group, and a super big group according to the member quantity. The small group may use a fast-channel delivery mode, and the big group and the super big group may use a slow-channel delivery mode. The super big group may further use a slow-channel delivery mode of subgroup pushing. In this exemplary solution, the pushing mode aiming at the big group and the super big group is an exemplary implementation in the above description in a case that the member quantity of the target group is greater than or equal to the third threshold. In this mode, the second threshold is the third threshold, and is a division threshold of the small group and the non-small group.

In some embodiments, in a case that the target group is a super big group, during message pushing, the target group may be pushed in a grouped mode to avoid too slow mass transmitting message pushing caused by excessive member quantity of the group. In some embodiments, the target group may be divided into at least two subgroups according to a preset threshold. The preset threshold is configured for limiting the member quantity of the group members corresponding to each subgroup. By using this grouping mode, dynamic grouping may be implemented based on the member quantity, and each subgroup corresponds to at least one shard. By using this solution, during target message pushing by the pushing server, each pushing aims at one subgroup, and the pushing server may acquire the member data of each member corresponding to one subgroup according to group indication information corresponding to the subgroup, and transmit the target message to each member corresponding to the subgroup.

According to some embodiments, in a case that the target group is a big group, i.e., the member quantity is greater than or equal to the second threshold but smaller than the first threshold, the first group indication information may include the first group identifier. In a case that the target group is a super big group, i.e., the member quantity is greater than or equal to the first threshold, the second group indication information may include the first group identifier and the subgroup index, or may include a second group index and the subgroup index.

In some embodiments, values of the subgroup indexes corresponding to the target group are respectively 0, 1, 2, . . . , and N−1, where N is a subgroup quantity, and N−1 is an N^{th} subgroup index. For any one subgroup index, member data of each member corresponding to the subgroup index may be acquired in the following mode:
determine a lower identifier limit and an upper identifier limit of the second member identifier corresponding to the subgroup index based on the second group identifier and the value of the subgroup index through following expressions:

Lower identifier limit=NewGroupCode<<(shardShift+shardIndexBit)+((PushShardIndex*(2^{shardIndexBit}/ShardNum))<<shardShift); and

upper identifier limit=NewGroupCode<<(shardShift+shardIndexBit)+(((PushShardIndex+1)*(2^{shardIndexBit}/ShardNum))<<shardShift).

In the expressions, NewGroupCode is a binary representation of the second group identifier, PushShardIndex represents a value of a subgroup index, shardIndexBit is the second set digit (i.e., a storage position occupied by the shard index) in the above descriptions, shardShift is the third set digit (i.e., a storage position occupied by the third member identifier of the member), and ShardNum is a group quantity, i.e., ShardNum=N.

According to the lower identifier limit and the upper identifier limit of the second member identifier corresponding to the subgroup index, member data of each member with the second member identifier being between the lower identifier limit and the upper identifier limit is acquired, and the acquired member data of each member is the member data of each member corresponding to the subgroup index.

In some embodiments, during actual implementation, in a case that the target group is a super big group, and the group logic layer or the pushing server needs to acquire the group member data of the super big group (for example, there is no local cache or the cache needs to be updated), for each subgroup, the upper identifier limit and the lower identifier limit of the second member identifier corresponding to the subgroup to be acquired may be determined based on the above expressions, so that the member data of each member corresponding to the subgroup may be acquired.

Specifically, for each subgroup, all second member identifiers (i.e., all MemberId meeting lower limit<MemberId<=upper limit) in a range of the lower identifier limit and the upper identifier limit of the second member identifier corresponding to the subgroup are identifiers of some members corresponding to this subgroup, and the member data of all members corresponding to the shard may be acquired. Therefore, by using such a mode, the members corresponding to the subgroup may be ensured to be accurately acquired, so that the member data of the members corresponding to the subgroup may be accurately acquired.

The group member data acquiring solution provided in some embodiments may also be used as an updating solution of the group member data. The group logic layer and the pushing server may update the cached data regularly or according to a notification in accordance with the group identifier (such as the first group identifier).

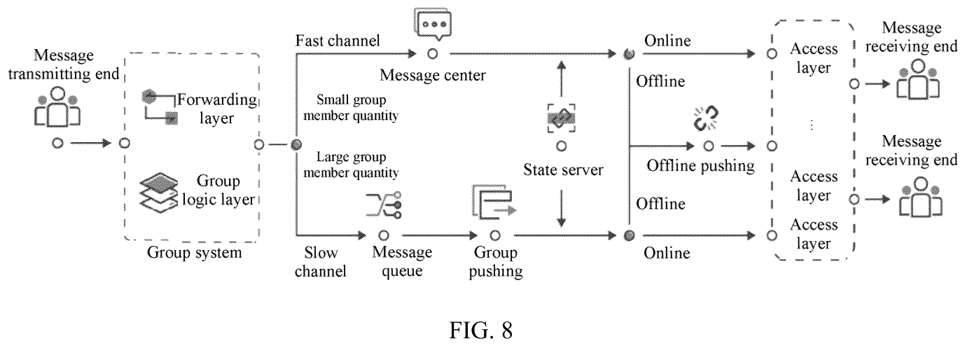

To better understand and illustrate the mass transmitting message pushing solution provided by some embodiments, an exemplary implementation solution will be further illustrated below with reference to FIG. 8. To avoid the problem that during mass transmitting message pushing, full group member data pulling may cause delay increase or even complete unavailability after the group member quantity increases to reach a certain threshold. As shown in FIG. 8, some embodiments may include the following flow process:

Operation 1: A forwarding layer receives a mass transmitting request aiming at a group 1 transmitted by a message transmitting end, and the request includes an original group code (OriginGroupCode) of the group 1.

Operation 2: The forwarding layer uses the OriginGroupCode as a key, and forwards the mass transmitting request to a target group logic layer corresponding to the OriginGroupCode by using consistent Hash.

Operation 3: The target group logic layer judges a quantity of group members of the current group, i.e., a member quantity, in a case that the group is a small group (the member quantity is small), the message is pushed to the group members in a fast-channel pushing mode; and in a case that the group is a big group or a super big group (the member quantity is great), the message is delivered to the group members in a slow-channel mode. In some embodiments, for the small group and the big group, member data of group members may be acquired through retrieval according to the OriginGroupCode of the group and OriginUserId of the member (for example, for 64-bit integers, the ID of the members in the group may be in an ascending mode from 1). After the quantity of group members reaches the super big group size, group member migration may be performed in the following mode:
1. Allocate a new group code NewGroupCode to a migrated group, and the code increases from 1; and allocate a new NewUserId to the group members, and the code of each group independently increases from 1.
2. Generate a second member identifier MemberId of each member. For each member, the MemberId is a 64-bit binary code, the high 28 bits are the NewGroupCode of the member, the low 28 bits are the NewUserId, and the middle 8 bits are the ShardIndex of the shard bits, and they may be acquired through OriginUserId % 256 calculation.
3. Newly add an index layer Member Index, and store a mapping relationship from the OriginGroupCode and the OriginUserId to the MemberId.
4. Migrate the group members to new storage (a second target storage node), and the MemberId of each member may be used as a shard key during distributed storage.

For this storage solution, in a case that the target group logic layer determines that the group 1 is a small group, to-be-pushed information corresponding to each member in the group 1 may be generated based on locally cached relevant information of each member in the group, and may be stored in a message center as shown in FIG. 8. In some embodiments, member state information of each member may be separately stored in a state server. A pushing server in a pushing server cluster consumes the to-be-pushed information in the message center. The pushing server may select an online or offline mode according to the online or offline state of each member in the group acquired from the state server, and transmit the mass transmitting message to a message receiving end of each member in the group 1 through an access layer.

In a case that the target group logic layer determines that the group 1 is a big group, the pushing of the mass transmitting message of the big group may include the following operations:
1. The target group logic layer may transmit a to-be-delivered message to a message queue by using the OriginGroupCode as a key. That is, the to-be-pushed information stored in the message queue (may be a message server) may include the OriginGroupCode and the target message to be pushed.
2. In some embodiments, according to the key, the message queue selects one group pushing server to consume the information in the queue by using a consistent hash load balance mode or another mode.
3. After acquiring the to-be-pushed information, the group pushing server may judge whether the group member data of the group is cached locally or not according to the OriginGroupCode. In a case that the group member data of the group is cached locally, according to the basic data and the state of the member, the target message is transmitted to the message receiving end through the access layer in an offline or online mode. In a case that the group member data of the group is not cached locally, the pushing server may execute the following operations:
a) Call the group logic service to pull the member data of all group members, for example, pull the member data of all members from the target group logic layer according to the OriginGroupCode. In some embodiments, the pushing server may pull the member data of all members in the group from a first target storage node (storage server) corresponding to the group based on the OriginGroupCode.
b) Call the state service to acquire corresponding group member state, for example, the member state of all members in the group are pulled from the state server according to the basic data of the group member (for example, an original member identifier of the group member).
c) Deliver the message to each member in the group by selecting online pushing or offline pushing according to the pulled member state.

In a case that the target group logic layer determines that the group 1 is a super big group (such as a group with a million of members), the pushing of the mass transmitting message of the super big group may include the following operations:
1. Acquire a current group member quantity through the basic group data.
2. Calculate how many shards (subgroups) does the group member need to be divided according to the member quantity of the group members. In some embodiments, the subgroup quantity ShardNum may be calculated by using the following formula:

ShardNum=align2((MemberNum)/(Threshold)).

In the formula, MemberNum is the quantity of the group members, i.e., the member quantity of the group, align 2 is the smallest power of 2 greater than or equal to the solved value through calculation, and Threshold is a threshold value, and may be configured and adjusted according to an actual requirement. As an example, supposed that MemberNum is 1 million, and the threshold is 50000, MemberNum/Threshold=20. Because 2⁴<20<2⁵, and align 2(20)=2⁵, ShardNum=align 2(20)=32, that is, the group may be divided into 32 groups.

For the above storage mode, a total quantity of the shards corresponding to the distributed storage is 256, so in a case that the subgroup quantity is 32, one subgroup may correspond to 8 shards. In some embodiments, the first subgroup corresponds to shards with the shard indexes being 0 to 7, the second subgroup corresponds to shards with the shard indexes being 8 to 15, and so on. The eighth subgroup corresponds to shards with the shard indexes being 248 to 255.
3. Traverse the ShardNum to generate a shard code PushShardIndex with the index values being 0 to ShardNum−1, i.e., the subgroup index. Each subgroup index may be combined with the group code GroupCode to be used as a key to be transmitted to the message queue. Specifically, for each subgroup, the to-be-pushed information corresponding to each subgroup is transmitted to the message queue. The to-be-pushed information corresponding to one subgroup may carry the group code GroupCode, the mass transmitting message, and a subgroup index of the subgroup. The group code and the subgroup index are group indication information, and are configured for determining each member corresponding to the subgroup to acquire relevant information of each member, so that the pushing server pushes the mass transmitting message to each member corresponding to the subgroup. In some embodiments, the group code in the to-be-pushed information may be OriginGroupCode or NewGroupCode.
4. The message queue selects a group pushing machine, i.e., a pushing server for consumption in a consistent hash load balance mode according to the key.
5. After acquiring the target message in the to-be-pushed information in the message queue, the group pushing machine may firstly judge whether the group member data of the group corresponding to the to-be-pushed information is cached locally or not. In a case that the group member data is cached locally, the mass transmitting message may be directly pushed to each member based on the group member data cached locally. In a case that the group member data is not cached locally, the group pushing machine may perform the following operations:
a) Call the group logic service to pull the member data of all group members. In some embodiments, the group pushing machine may pull the member data from the target group logic layer according to the group code in the to-be-pushed information. In some embodiments, in a case that the group code carried in the to-be-pushed information is NewGroupCode, correspondingly to each subgroup, the group pushing machine may also pull the member data of each member of the shard in the group from these shards based on the NewGroupCode according to each shard corresponding to the subgroup.
b) Call the state service to acquire the state of the corresponding group member.
6. Select online pushing or offline pushing for delivering the message to the user according to the state.

As an exemplary solution, for any one group, a version code Version may be allocated to the target group logic layer corresponding to the group every time when a group member joins in and exits from the group, and the version code starts to increase from 1. Regardless of whether a new member joins the group or a member exits from the group, the member version code of the new member is a value of adding 1 to the original version code. The version code change represents the group member change. The change may be group joining of a member, or may be group existing of a member. When the group member changes, a specific change condition of the group member may be identified through the updated version code and the specific change content (for example, which member or members are newly added and which member exits from the group in comparation to the version code before the updating). Whether the group member changes or not may be known by acquiring the current latest version code of the group. In a case that the group member changes, which members change specifically may be acquired. Of course, the change of the group member quantity may also be recorded in another mode. By recording the change condition of the group member information, incremental updating of the member data may be realized. For example, in a case that the pushing server needs to pull the latest data of the group member, for example, update the cached basic data of the group member, the pushing server may acquire the current latest version code V1 of the group, and compare the cached group version code V0 to the V1. In a case that the V0 and the V1 are the same, it indicates that the group member does not change, and updating is not needed. If the V0 and the V1 are different, it indicates that the group member information changes, and the pushing server may acquire the specific member change condition from the group logic layer. For example, in a case that a comparison result to the version V0 shows that a member a and a member b exit from the group, the pushing server may delete the cached data of the member a and the member b.

In some embodiments, the group member data cached in the group logic layer or the pushing server, such as the basic member data and the state information, may be updated according to a preconfigured update strategy. For example, the group member data may be updated according to a preset update interval, or of course may be updated in real time each time the member data needs to be used. For example, during mass transmitting message pushing, the pushing server acquires the member data of each member to be pushed according to the to-be-pushed information to be consumed. The update intervals of the basic group data and the state information may be different. For the small group, the member quantity is small, so a full update strategy may be adopted, and of course, an incremental update strategy may also be adopted. An exemplary acquiring solution of group member data of the big group and the super big group will be illustrated below by taking the pushing server acquiring or updating the cached member data of the group members as an example.

For a big group, a local group member cache updating solution of the big group in the group pushing service may be in a full pulling mode, a regular incremental updating mode, or a real-time notification updating mode.
1. A full pulling flow process may include:
a) Consume a message pushing event to acquire a group code OriginGroupCode.
b) Acquire a maximum version code, recorded as Vmax1, of the current group members (for example, acquire from the group logic layer transmitting the to-be-pushed information to be consumed) through the group code OriginGroupCode.
c) Perform sorting according to the version code. Data of all group members with the version code meeting Version≤Vmax1 in the group corresponding to the group code may be pulled in a pagination mode based on the group code.
2. A regular updating solution corresponding to the big group (this solution may be configured for ensuring the final consistency during real-time notification fault) may include:
a) Acquire a maximum version code, recorded as Vmaxn, of the current group members, and it may be acquired from the group logic layer according to the group code OriginGroupCode.
b) Record the maximum version code of the group members acquired through full pulling or regular updating last time as Vmaxn−1.
c) Perform sorting according to the version code. All group members with the version code meeting Vmaxn-1<Version<=Vmax1 are pulled in a pagination mode.
3. The real-time notification mode corresponding to the big group may include:
a) The group logic service, i.e., the group logic layer may transmit information to the message queue by using the OriginGroupCode as a key after the group member joins the group. At this moment, the information transmitted to the message queue is configured for notifying the pushing server of member change information in the group corresponding to the group code OriginGroupCode. The pushing server may know which members are newly added to the group according to the information, so as to timely update the group member data locally cached by the pushing server. Therefore, when a mass transmitting message of the group needs to be pushed, the mass transmitting message needs to be pushed to newly added members, but does not need to be pushed to members who have exited from the group.
b) After the group members exit from the group, the group logic service transmits the information to the message queue by using the OriginGroupCode as a key. At this moment, the information transmitted to the message queue is configured for notifying the pushing server which members in the group have exited, and messages do not need to be pushed to these members in a subsequent process.
c) The group pushing service consumes the group member change events (including a member newly adding event or a member group exiting event, i.e., information transmitted to the message queue in a) and b)) to update a local group member cache.

For a super big group, a local group member cache updating solution of the big group in the group pushing service may also be in a full pulling mode, a regular incremental updating mode, or a real-time notification updating mode. Specific processes are as follows:
1. Full pulling:
a) Consume a message pushing event to acquire a group code GroupCode and a pushing shard code PushShardIndex.
b) Acquire a maximum version code of the current group members, and record as Vmax1.

c) Calculate a group member code MemberId range belonging to the current shard code according to following calculation formulas:

lower limit (MemberId lower limit)=NewGroupCode<<(shardShift+shardIndexBit)+((PushShardIndex*(2 shardIndexBit/ShardNum))<<shardShift); and

upper limit (MemberId upper limit)=NewGroupCode<<(shardShift+shardIndexBit)+(((PushShardIndex+1)*(2 shardIndexBit/ShardNum))<<shardShift).

In the formulas, shardShift=64−NewGroupCodeBit−ShardIndexBit, shardIndexBit is a number of binary bits, i.e., 8 bits, and NewGroupCodeBit is a binary digit of NewGroupCode, i.e., 28 bits.
d) Perform sorting according to the version code. All group members having the version code meeting Version≤Vmax1 and satisfying lower limit<MemberId<=upper limit are pulled in a pagination mode.
2. Regular incremental update (configured for ensuring the final consistency during real-time notification fault):
a) Acquire a maximum version code of the current group members, and record as Vmaxn.
b) Record the maximum version code of the group members acquired through full pulling or regular updating last time as Vmaxn−1.
c) Perform sorting according to the version code. Group members having the version code meeting Vmaxn−1<Version<=Vmax1 and satisfying lower limit<MemberId<=upper limit are pulled in a pagination mode.
3. Real-time notification:
a) After a group member joins the group or exits from the group, the group logic service transmits the information to the message queue by using the GroupCode and the pushing shard code PushShardIndex to which the group member belongs as keys, and a calculation formula of the PushShardIndex here is as follows:

PushShardIndex=(MemberId>>NewUserIdBit) & (2 shardIndexBit−1).

In the formula, NewUserIdBit is a binary digit of NewUserId, i.e., a binary digit of a third member identifier.
b) After a group member joins the group or exits from the group, the group logic service transmits the information to the message queue by using the GroupCode and the pushing shard code PushShardIndex to which the group member belongs as keys.
c) The group pushing service consumes the group member change events to update the local group member cache.

For the small group, the big group, and the super big group, during mass transmitting message pushing, the state of the group members in the local cache further needs to be updated, and the latest member state needs to be acquired in time to determine whether to perform offline pushing or online pushing to the member. In some embodiments, the member quantity of the small group is small, and a full fulling solution of the member state may be adopted. For the big group and the super big group, a solution of full pulling, regular updating, or real-time updating according to a notification may be adopted.

In some embodiments, for the big group, an updating solution of pushing the local group member state required by the service may be in any one of the following modes:
1. Full pulling: Call the state service to acquire the group member state after full group members (basic member data) are acquired.
2. Regular updating (configured for ensuring the final consistency during real-time notification fault): A full group member calling state service acquires the group member state (may achieve the same effect as full pulling on implementation).
3. Real-time notification:
a) In a case that the user state changes, the group logic layer acquires member addition to a group list, traverses the group by using the group code GroupCode as a key, and transmits the information to the message queue (that is, adding a group member state change event to the message queue) to notify the pushing server that the member states of which members change, for example, the state of which members changes from an online state to an offline state, and the state of which members changes from the offline state to the online state.
b) The group pushing service consumes the group member state change events to update the local group member state cache.

In some embodiments, for the super big group, an updating solution of pushing the local group member state required by the service may be in any one of the following modes:
1. Full pulling: Call the state service to acquire the group member state after full group members are acquired.
2. Regular updating (configured for ensuring the final consistency during real-time notification fault): The full group member calling state service acquires the group member state.
3. Real-time notification:
a) In a case that the user state changes, the group logic acquires a list of groups which have been joined by the user, traverses the group, and transmits information to the message queue by using the group code GroupCode and the pushing shard code PushShardIndex to which the group member belongs as keys to notify the pushing server that the state of the member in which subgroup or subgroups changes.
b) The group pushing service consumes the group member state change events to update the local group member state cache.

Various exemplary solutions provided by some embodiments may effectively solve one or more problems in various problems caused by continuous increasing of the group member quantity. By using the solutions provided in the embodiments of this application, communication requirements of the big group and the super big group (for example, a million-level group) may be well met, a implementing difficulty of the super big group may be solved, various core problems such as message receiving and transmitting, group member storage, and message pushing of the million-level group may be resolved, and chat experience of members may be ensured to be identical to that of members in a small group.

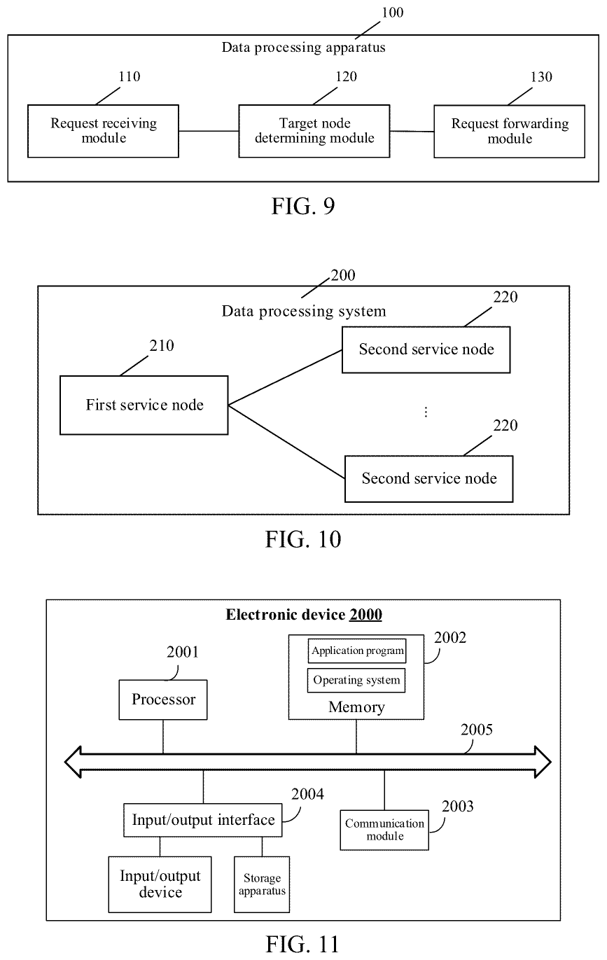

Based on a principle the same as that of the data processing method according to some embodiments, some embodiments provide a data processing apparatus. The apparatus may be implemented as any one electronic device such as a server. As shown in FIG. 9, a data processing apparatus 100 may include: a request receiving module 110, a target node determination module 120, and a request forwarding module 130.

The request receiving module 110 is configured to acquire a service processing request related to a target group, and the service processing request includes a first group identifier of the target group.

The target node determination module 120 is configured to determine target service nodes corresponding to the service processing request from a plurality of second service nodes according to the first group identifier. The target service nodes are some nodes among the plurality of second service nodes, the target service nodes cache basic group data of the target group, and second service nodes other than the target service nodes do not cache the basic group data of the target group.

The request forwarding module 130 is configured to transmit the service processing request to the target service nodes, such that the target service nodes perform processing on the service processing request according to relevant data of the target group, and the relevant data includes the basic group data of the target group.

In some embodiments, the service processing request includes a request relevant to member data of at least one member in the target group. The member data of each member in the target group is acquired in the following mode:
acquire a second member identifier of each member in the target group.

For any one member in the target group, a second target storage node corresponding to the member is determined from the plurality of second storage nodes according to the second member identifier of the member, and the member data of the member is stored in the second target storage node.

In some embodiments, the second member identifier of each member is acquired in the following mode:
determine a member quantity of the target group.

In a case that the member quantity is greater than or equal to a first threshold, the second member identifier of each member in the target group is generated, a mapping relationship between an old identifier and the second member identifier of each member is recorded and stored, and the old identifier of one member includes a first member identifier of the member and the first group identifier.

In a case that the member quantity is smaller than the first threshold, the member data of each member in the target group is stored in the following modes:
determine a first target storage node corresponding to the target group from a plurality of first storage nodes according to the first group identifier.

The member data of each member in the target group is stored into the first target storage node based on the first member identifier of each member in the target group.

In some embodiments, for any one member in the target group, the member data of the member is acquired in the following mode:
determine a member quantity of the target group.

In a case that the member quantity is smaller than the first threshold, the first target storage node corresponding to the target group is determined based on the first group identifier, and the member data of the member is acquired from the first target storage node based on the first member identifier of the member.

In a case that the member quantity is greater than or equal to the first threshold, the second member identifier of the member is determined according to the old identifier of the member and the mapping relationship, the second target storage node corresponding to the member is determined according to the second member identifier of the member, and the member data of the member is acquired from the determined second target storage node.

In some embodiments, for any one member in the target group, the second member identifier of the member is generated in the following mode:
determine a second group identifier of the target group and a third member identifier of the member.

According to the first member identifier of the member and a total quantity of shards corresponding to the plurality of second storage nodes, a target shard index corresponding to the member is determined.

The second member identifier of the member is generated based on the second group identifier, the target shard index of the member, and the third member identifier.

In some embodiments, the second group identifiers of different groups use continuous digital codes, and the third member identifier of each member in the target group uses continuous digital codes.

For any one member, the second member identifier of the member is a binary coded identifier, and in a descending order, the binary coded identifier corresponding to the member includes:
a binary representation of a first set digit corresponding to the second group identifier of the target group, a binary representation of a second set digit corresponding to the target shard index of the member, and a binary representation of a third set digit corresponding to the third member identifier of the member.

In some embodiments, the service processing request includes a mass transmitting request of a target message. The target message is transmitted by the target service nodes in the following mode:
acquire the member data of each member in the target group based on the first group identifier in a case that the member quantity is smaller than the second threshold; and generate, for each member, to-be-pushed information corresponding to the member according to the member data of the member and the target message, so that a first pushing server pushes the target message to the member based on the to-be-pushed information corresponding to the member.

In a case that the member quantity is greater than or equal to a second threshold but is smaller than the first threshold, the to-be-pushed information corresponding to the target group is generated, so that a second pushing server acquires the member data of all members in the target group according to first group indication information in the to-be-pushed information, and pushes the target message in the to-be-pushed information to each member according to the member data of each member.

In a case that the member quantity is greater than or equal to the first threshold, a subgroup quantity corresponding to the target group is determined according to the member quantity, and the corresponding quantity of subgroup indexes are generated, where each of the subgroup indexes corresponds to some members in the target group, different subgroup indexes correspond to different members, and each of the subgroup indexes corresponds to at least one shard.

For each of the subgroup indexes, based on the target message and the subgroup index, to-be-pushed information corresponding to the subgroup index is generated, so that a third pushing server acquires the member data of each member corresponding to the subgroup index in the target group according to second group indication information in the to-be-pushed information, and pushes the target message in the to-be-pushed information corresponding to the subgroup index to each member according to the member data of each member.

In some embodiments, values of the subgroup indexes corresponding to the target group are respectively 0, 1, 2, . . . , and N−1, where N is a subgroup quantity, and N−1 is an N^{th} subgroup index. For any one subgroup index, the member data of each member corresponding to the subgroup index is acquired in the following mode:
determine a lower identifier limit and an upper identifier limit of the second member identifier corresponding to the subgroup index through following expressions:

lower identifier limit=NewGroupCode<<(shardShift+shardIndexBit)+((PushShardIndex*(2^{shardIndexBit}/ShardNum))<<shardShift); and

upper identifier limit=NewGroupCode<<(shardShift+shardIndexBit)+(((PushShardIndex+1)*(2^{shardIndex} Bit/ShardNum))<<shardShift).

In the expressions, NewGroupCode is a binary representation of the second group identifier, PushShardIndex represents a value of the subgroup index, shardIndexBit is the second set digit, shardShift is the third set digit, and ShardNum=N.

According to the lower identifier limit and the upper identifier limit of the second member identifier corresponding to the subgroup index, member data of each member with the second member identifier being between the lower identifier limit and the upper identifier limit is acquired, and the acquired member data of each member is the member data of each member corresponding to the subgroup index.

In some embodiments, the service processing request includes a mass transmitting request of the target message. The target message is transmitted by the target service nodes in the following mode:
determine a member quantity of the target group.

In a case that the member quantity is smaller than a third threshold, the member data of each member in the target group is acquired, and for each member in the target group, to-be-pushed information corresponding to the member and including the target message is generated according to the member data of the member, so that a fourth pushing server pushes the target message to the member based on the to-be-pushed information.

In a case that the member quantity is greater than or equal to the third threshold, to-be-pushed information corresponding to the target group is generated, so that a fifth pushing server acquires the member data of each member in the target group according to third group indication information in the to-be-pushed information, and pushes the target message in the to-be-pushed information to each member according to the member data of each member.

In some embodiments, the member data of each member in the target group is acquired in the following mode:
acquire the member data of each member in the target group from a local cache in a case that the member data of each member in the target group exists in the local cache; and
acquire the member data of each member in the target group from target storage nodes storing the member data of each member in the target group in a case that no member data of each member in the target group exists in the local cache, and cache the acquired member data into the local cache.

In some embodiments, the operation of determining the target service nodes corresponding to the service processing request from the plurality of second service nodes according to the first group identifier includes:
determine, according to the first group identifier, a first mapping identifier corresponding to the first group identifier through a preconfigured identifier mapping rule;
acquire a second mapping identifier of each node in the plurality of second service nodes, where the second mapping identifier of each of the second service nodes is determined through a preconfigured target mapping rule according to the node identifier of the second service node; and
determine the target service nodes from the plurality of second service nodes according to a matching degree of the first mapping identifier and the second mapping identifier of each of the second service nodes.

In this application, the accuracy of a correspondence relationship between the first mapping identifier and the second mapping identifier may be ensured by separately determining the first mapping identifier and the second mapping identifier, and then matching the first mapping identifier and the second mapping identifier.

The apparatus in the embodiments of this application may perform the method provided in the embodiments of this application, and an implementation principle thereof is similar. Actions performed by each module in the apparatus of each embodiment of this application correspond to operations in the method of each embodiment of this application. For detailed function descriptions of each module of the apparatus, reference may be made to descriptions in corresponding methods shown above, which will not be repeated herein.

According to some embodiments, each module in the apparatus may exist respectively or be combined into one or more units. Certain (or some) unit in the units may be further split into multiple smaller function subunits, thereby implementing the same operations without affecting the technical effects of some embodiments. The modules are divided based on logical functions. In actual applications, a function of one module may be realized by multiple units, or functions of multiple modules may be realized by one unit. In some embodiments, the apparatus may further include other units. In actual applications, these functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

Some embodiments provide a data processing system. As shown in FIG. 10, a data processing system 200 may include at least one first service node 210 and a plurality of second service nodes 220 in communication connection with the at least one first service node. For any one group, some nodes in the plurality of second service nodes cache basic group data of the group, and each second service node is associated with a first group identifier of at least one group.

The first service node 210 is configured for receiving a service processing request related to a target group, determining target service nodes corresponding to the service processing request from the plurality of second service nodes according to the first group identifier of the target group included in the service processing request, and transmitting the service processing request to the target service nodes.

The second service node 220 is configured for receiving the service processing request transmitted by the first service node, and processing the service processing request according to cached relevant data of the group corresponding to the service processing request, and the relevant data of the group includes the basic group data of the group.

In some embodiments, the system may further include at least one access node. The first service node 210 receives the service processing request transmitted by the access node. In some embodiments, the system may further include at least one pushing server. In a case that the service processing request is a mass transmitting request of a target message, the second service node 220 pushes the target message to each member in the target group through the pushing server.

Some embodiments provide an electronic device. The electronic device includes at least one processor, and the processor is configured to perform the operations of the method provided by any one exemplary embodiment of this application. In some embodiments, the electronic device may further include a transceiver and/or a memory coupled to the processor. The memory has a computer program stored therein. When running the computer program, the processor may implement the solution provided by any one exemplary embodiment of this application. In some embodiments, the electronic device may be a user terminal or a server.

FIG. 11 shows a schematic structural diagram of an electronic device applicable to some embodiments. As shown in FIG. 11, the electronic device may be a server or a user terminal, and the electronic device may be configured for implementing the method provided by any one embodiment.

As shown in FIG. 11, an electronic device 2000 may mainly include components such as at least one processor 2001 (one is shown in FIG. 11), a memory 2002, a communication module 2003, and an input/output interface 2004. In some embodiments, connection and communication may be realized among the components through a bus 2005. A structure of the electronic device 2000 shown in FIG. 11 is merely exemplary, and does not constitute a limitation to the electronic device applicable to the method provided by the embodiments of this application.

The memory 2002 may be configured to store an operating system, an application program, and the like. The application program may include a computer program implementing the method provided by the embodiments of the disclosure when being called by the processor 2001, and may further include a program configured for implementing other functions or services. The memory 2002 may be a read only memory (ROM) or another type of static storage device capable of storing static information and instructions, a random access memory (RAM) or another type of dynamic storage device capable of storing information and computer programs, or may be an electrically erasable programmable read only memory (EEPROM), a compact disc read only memory (CD-ROM) or another optical disk memory, an optical disk memory (including a compact disc, a laser disk, an optical disk, a digital universal disk, a blue-ray disc, and the like), a magnetic disk storage medium or another magnetic storage device, or any other medium capable of being used for carrying or storing expected program codes in an instruction or a data structure form and capable of being accessed by a computer, but it is not limited thereto.

The processor 2001 is connected with the memory 2002 through the bus 2005, and realizes corresponding functions by calling the application programs stored in the memory 2002. The processor 2001 may be a central processing unit (CPU), a general purpose processor, a digital signal processor (DSP), an application specific integrated circuit (ASIC), a field programmable gate array (FPGA), or another programmable logic device, a transistor logic device, a hardware component or a free combination thereof, and it may realize or implement various exemplary logic boxes, modules, and circuits combined with descriptions of the disclosed contents of the disclosure. The processor 2001 may be a combination capable of realizing a computing function, for example, including a combination of one or a plurality of microprocessors, or a combination of a DSP and a microprocessor, and the like.

The electronic device 2000 may be connected to a network through the communication module 2003 (may include but not limited to components such as a network interface) to communicate with another device (such as a user terminal or a server) through the network for realizing data exchange, such as data transmission to other devices or data receiving from other devices. The communication module 2003 may include a wired network interface, and/or a wireless network interface, and the like. That is, the communication module may include at least one of a wired communication module or a wireless communication module.

The electronic device 2000 may be connected to a required input/output device such as a keyboard or a display device through the input/output interface 2004. The electronic device 2000 may have a display device, or may be externally connected with another display device through the interface 2004. In some embodiments, a storage apparatus such as a hard disk may further be connected through the interface 2004, so that data in the electronic device 2000 may be stored into the storage apparatus, or data in the storage apparatus may be read, and data in the storage apparatus may further be stored into the memory 2002. The input/output interface 2004 may be a wired interface, or may be a wireless interface. According to different actual application scenarios, a device connected to the input/output interface 2004 may be a component of the electronic device 2000, or may be an external device connected with the electronic device 2000 when required.

The bus 2005 configured to connect the components may include a channel to transmit information among the components. The bus 2005 may be a peripheral component interconnect (PCI) bus, an extended industry standard architecture (EISA) bus, and the like. According to different functions, the bus 2005 may be classified into an address bus, a data bus, a control bus, and the like.

In some embodiments, for the solutions provided by the embodiments, the memory 2002 may be configured to store a computer program implementing the solutions of the disclosure and operating by the processor 2001. When running the computer program, the processor 2001 implements the method or actions of the apparatus provided by the embodiments of the disclosure.

Some embodiments provide a computer-readable storage medium. The computer-readable storage medium has a computer program stored therein, and the computer program, when executed by a processor, may implement corresponding contents of the above method embodiments.

Some embodiments provide a computer program product, which includes a computer program. The computer program, when executed by a processor, may implement corresponding contents of the above method embodiments.

The terms such as “first”, “second”, “third”, “fourth”, “1”, “2” (if any) in the description and claims of this application and in the accompanying drawings are used for distinguishing similar objects and not necessarily used for describing a particular order or sequence. Such used data is interchangeable under proper conditions so that the embodiments of this application described herein may be implemented in an order other than those illustrated or described in the figures or by texts.

Although each operation is indicated through arrows in a flow chart, the implementation sequence of these operations is not limited to the sequence indicated by the arrows. Unless explicitly described in the specification, in some embodiments, implementation operations in each flow chart may be performed in other sequences according to requirements. In addition, some or all of the operations in each flow chart may be based on an actual implementation scenario, and may include a plurality of sub-operations or a plurality of stages. Some or all of these sub-operations or stages may be performed at the same moment, and each of these sub-operations or stages may be separately performed at different moments. In a scenario of different execution moments, the execution sequence of these sub-operations or stages may be flexibly configured according to requirements. This is not limited herein.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data processing method, comprising:
acquiring, by a first service node in a group forwarding layer, a service processing request related to a target group from an access layer, the service processing request comprising a first group identifier of the target group;
determining, by the first service node, target service nodes caching basic group data of the target group from a plurality of second service nodes in a group logic layer according to the first group identifier, the target service nodes being some nodes among the plurality of second service nodes; and
transmitting, by the first service node, the service processing request to the target service nodes, such that the target service nodes determine a member size of the target group according to the basic group data of the target group and perform processing on the service processing request according to the member size of the target group.

2. The data processing method according to claim 1, wherein the service processing request comprises a request relevant to member data of at least one member in the target group; the service processing request further comprises a first member identifier of each of the at least one member; and
wherein determining the member size of the target group according to the basic group data of the target group and performing processing on the service processing request according to the member size of the target group comprises:
determining, based on a determination that a member quantity of the target group is greater than or equal to a first threshold according to the basic group data of the target group, the target group to be a set super big group, and based on a pre-established mapping relationship of the first group identifier and the first member identifier to a second member identifier, determining a second member identifier corresponding to each of the at least one member according to the first group identifier and at least one first member identifier in the service processing request; and
determining, according to the second member identifier of each of the at least one member, a second target storage node corresponding to the member from a plurality of second storage nodes, and acquiring member data of the member from the determined second target storage node.

3. The data processing method according to claim 2, wherein determining the member size of the target group according to the basic group data of the target group and performing processing on the service processing request according to the member size of the target group further comprises:
determining, based on a determination that the member quantity of the target group is smaller than the first threshold according to the basic group data of the target group, the target group to be a non-set super big group, determining a first target storage node corresponding to the target group based on the first group identifier, and acquiring member data of the member from the first target storage node based on the first member identifier of the member.

4. The data processing method according to claim 2, wherein the second member identifier is generated in the following mode:
determining, based on the target group being determined to be the set super big group, a second group identifier of the target group and a third member identifier of the member;
determining a target shard index corresponding to the member according to the first member identifier of the member and a total quantity of shards corresponding to the plurality of second storage nodes; and
generating the second member identifier of the member based on the second group identifier, the target shard index of the member, and the third member identifier.

5. The data processing method according to claim 4, wherein the second group identifiers of different groups use continuous digital codes, and the third member identifier of each member in the target group uses continuous digital codes; and
for at least one of the at least one member, the second member identifier of the member is a binary coded identifier, and in a descending order, the binary coded identifier corresponding to the member comprises:
a binary representation of a first set digit corresponding to the second group identifier of the target group, a binary representation of a second set digit corresponding to the target shard index of the member, and a binary representation of a third set digit corresponding to the third member identifier of the member.

6. The data processing method according to claim 1, wherein the service processing request comprises a mass transmitting request of a target message, and
wherein determining the member size of the target group according to the basic group data of the target group and performing processing on the service processing request according to the member size of the target group comprises:
determining, based on the member quantity of the target group being smaller than a second threshold, the target group to be a set small group, and acquiring member data of each member in the target group based on the first group identifier; generating, for each member, to-be-pushed information corresponding to the member according to the member data of the member and the target message, so that a first pushing server pushes the target message to the member based on the to-be-pushed information corresponding to the member; and
determining, based on the member quantity of the target group being greater than or equal to the second threshold and smaller than the first threshold, the target group to be a set big group, and generating to-be-pushed information corresponding to the target group, so that a second pushing server acquires member data of all members in the target group according to first group indication information in the to-be-pushed information, and pushes the target message in the to-be-pushed information to each member according to the member data of each member.

7. The data processing method according to claim 6, wherein the determining the member size of the target group according to the basic group data of the target group and performing processing on the service processing request according to the member size of the target group further comprises:
determining, based on the member quantity of the target group being greater than or equal to the first threshold, the target group to be the set super big group, determining a subgroup quantity corresponding to the target group according to the member quantity, and generating a corresponding quantity of subgroup indexes, wherein each of the subgroup indexes corresponds to some members in the target group, different subgroup indexes correspond to different members, and each of the subgroup indexes corresponds to at least one shard; and
generating, for each of the subgroup indexes, to-be-pushed information corresponding to the subgroup index based on the target message and the subgroup index, so that a third pushing server acquires member data of each member corresponding to the subgroup index in the target group according to second group indication information in the to-be-pushed information, and pushes the target message in the to-be-pushed information corresponding to the subgroup index to each member according to the member data of each member.

8. The data processing method according to claim 1, wherein the service processing request comprises a mass transmitting request of a target message, and
performing processing on the service processing request according to the member size of the target group comprises:
determine, based on the member quantity of the target group being smaller than a third threshold, the target group to be a set small group, acquire the member data of each member in the target group, and generate, for each member in the target group, to-be-pushed information corresponding to the member and comprising the target message according to the member data of the member, so that a fourth pushing server pushes the target message to the member based on the to-be-pushed information; and
determine, based on the member quantity of the target group being greater than or equal to the third threshold, the target group to be a non-set small group, and generate to-be-pushed information corresponding to the target group, so that a fifth pushing server acquires the member data of each member in the target group according to third group indication information in the to-be-pushed information, and pushes the target message in the to-be-pushed information to each member according to the member data of each member.

9. The data processing method according to claim 8, wherein the acquiring the member data of each member in the target group comprises:
acquiring, based on the member data of each member in the target group existing in a local cache, the member data of each member in the target group from the local cache; and
acquiring, based on no member data of each member in the target group existing in the local cache, the member data of each member in the target group from target storage nodes storing the member data of each member in the target group, and cache the acquired member data into the local cache.

10. The data processing method according to claim 1, wherein determining the target service nodes caching basic group data of the target group from a plurality of second service nodes in a group logic layer according to the first group identifier comprises:
determining, according to the first group identifier, a first mapping identifier corresponding to the first group identifier through a preconfigured identifier mapping rule;
acquiring a second mapping identifier of each node in the plurality of second service nodes, wherein the second mapping identifier of each of the second service nodes is determined through a preconfigured target mapping rule according to the node identifier of the second service node; and
determining the target service nodes from the plurality of second service nodes according to a matching degree of the first mapping identifier and the second mapping identifier of each of the second service nodes.

11. A data processing apparatus, disposed in a first service node of a group forwarding layer, and comprising:
at least one memory configured to store program code; and
at least one processor configured to read the program code and operate as instructed by the program code, the program code comprising:
request receiving code configured to cause at least one of the at least one processor to acquire a service processing request related to a target group from an access layer, the service processing request comprising a first group identifier of the target group;
target node determination code configured to cause at least one of the at least one processor to determine target service nodes caching basic group data of the target group from a plurality of second service nodes in a group logic layer according to the first group identifier, the target service nodes being some nodes among the plurality of second service nodes; and
request forwarding code configured to cause at least one of the at least one processor to transmit the service processing request to the target service nodes, such that the target service nodes determine a member size of the target group according to the basic group data of the target group and perform processing on the service processing request according to the member size of the target group.

12. The data processing apparatus according to claim 11, wherein the service processing request comprises a request relevant to member data of at least one member in the target group; the service processing request further comprises a first member identifier of each of the at least one member; and
wherein the request forwarding code is further configured to cause at least one of the at least one processor to:
determine, based on a determination that a member quantity of the target group is greater than or equal to a first threshold according to the basic group data of the target group, the target group to be a set super big group, and based on a pre-established mapping relationship of the first group identifier and the first member identifier to a second member identifier, determining a second member identifier corresponding to each of the at least one member according to the first group identifier and at least one first member identifier in the service processing request; and
determine, according to the second member identifier of each of the at least one member, a second target storage node corresponding to the member from a plurality of second storage nodes, and acquiring member data of the member from the determined second target storage node.

13. The data processing apparatus according to claim 12, wherein the request forwarding code is further configured to cause at least one of the at least one processor to:
determine, based on a determination that the member quantity of the target group is smaller than the first threshold according to the basic group data of the target group, the target group to be a non-set super big group, determining a first target storage node corresponding to the target group based on the first group identifier, and acquiring member data of the member from the first target storage node based on the first member identifier of the member.

14. The data processing apparatus according to claim 12, wherein the second member identifier is generated in the following mode:
determining, based on the target group being determined to be the set super big group, a second group identifier of the target group and a third member identifier of the member;
determining a target shard index corresponding to the member according to the first member identifier of the member and a total quantity of shards corresponding to the plurality of second storage nodes; and
generating the second member identifier of the member based on the second group identifier, the target shard index of the member, and the third member identifier.

15. The data processing apparatus according to claim 14, wherein the second group identifiers of different groups use continuous digital codes, and the third member identifier of each member in the target group uses continuous digital codes; and
for at least one of the at least one member, the second member identifier of the member is a binary coded identifier, and in a descending order, the binary coded identifier corresponding to the member comprises:
a binary representation of a first set digit corresponding to the second group identifier of the target group, a binary representation of a second set digit corresponding to the target shard index of the member, and a binary representation of a third set digit corresponding to the third member identifier of the member.

16. The data processing apparatus according to claim 11, wherein the service processing request comprises a mass transmitting request of a target message, and
wherein the request forwarding code is further configured to cause at least one of the at least one processor to:
determine, based on the member quantity of the target group being smaller than a second threshold, that the target group is a set small group, and acquire member data of each member in the target group based on the first group identifier; generating, for each member, to-be-pushed information corresponding to the member according to the member data of the member and the target message, so that a first pushing server pushes the target message to the member based on the to-be-pushed information corresponding to the member; and
determine, based on the member quantity of the target group being greater than or equal to the second threshold and smaller than the first threshold, the target group to be a set big group, and generate to-be-pushed information corresponding to the target group, so that a second pushing server acquires member data of all members in the target group according to first group indication information in the to-be-pushed information, and pushes the target message in the to-be-pushed information to each member according to the member data of each member.

17. The data processing apparatus according to claim 16, wherein the request forwarding code is further configured to cause at least one of the at least one processor to:
determine, based on the member quantity of the target group being greater than or equal to the first threshold, the target group to be the set super big group, determining a subgroup quantity corresponding to the target group according to the member quantity, and generate a corresponding quantity of subgroup indexes, wherein each of the subgroup indexes corresponds to some members in the target group, different subgroup indexes correspond to different members, and each of the subgroup indexes corresponds to at least one shard; and
generate, for each of the subgroup indexes, to-be-pushed information corresponding to the subgroup index based on the target message and the subgroup index, so that a third pushing server acquires member data of each member corresponding to the subgroup index in the target group according to second group indication information in the to-be-pushed information, and pushes the target message in the to-be-pushed information corresponding to the subgroup index to each member according to the member data of each member.

18. The data processing apparatus according to claim 11, wherein the service processing request comprises a mass transmitting request of a target message, and
wherein the request forwarding code is further configured to cause at least one of the at least one processor to:
determine, based on the member quantity of the target group being smaller than a third threshold, the target group to be a set small group, acquire the member data of each member in the target group, and generate, for each member in the target group, to-be-pushed information corresponding to the member and comprising the target message according to the member data of the member, so that a fourth pushing server pushes the target message to the member based on the to-be-pushed information; and
determine, based on the member quantity of the target group being greater than or equal to the third threshold, the target group to be a non-set small group, and generate to-be-pushed information corresponding to the target group, so that a fifth pushing server acquires the member data of each member in the target group according to third group indication information in the to-be-pushed information, and pushes the target message in the to-be-pushed information to each member according to the member data of each member.

19. The data processing apparatus according to claim 18, wherein the request forwarding code is further configured to cause at least one of the at least one processor to:
acquire, based on the member data of each member in the target group existing in a local cache, the member data of each member in the target group from the local cache; and
acquire, based on no member data of each member in the target group existing in the local cache, the member data of each member in the target group from target storage nodes storing the member data of each member in the target group, and caching the acquired member data into the local cache.

20. A non-transitory computer-readable storage medium, storing computer code which, when executed by at least one processor, causes the at least one processor to at least:
acquire, by a first service node in a group forwarding layer, a service processing request related to a target group from an access layer, the service processing request comprising a first group identifier of the target group;
determine, by the first service node, target service nodes caching basic group data of the target group from a plurality of second service nodes in a group logic layer according to the first group identifier, the target service nodes being some nodes among the plurality of second service nodes; and
transmit, by the first service node, the service processing request to the target service nodes, such that the target service nodes determine a member size of the target group according to the basic group data of the target group and perform processing on the service processing request according to the member size of the target group.
